(19) United States
(12) Patent Application Publication
(10) Pub. No.: US 2025/0286070 A1
(43) Pub. Date: Sep. 11, 2025

(54) EMBEDDED ELECTRODE ASSEMBLY (EMELA)

(71) Applicant: INNOVASION LABS PINC, INC., San Diego, CA (US)

(72) Inventor: Inanc ORTAC, San Diego, CA (US)

(21) Appl. No.: 18/859,978

(22) PCT Filed: Apr. 25, 2023
(86) PCT No.: PCT/US2023/019856

§ 371 Date: Oct. 24, 2024

Related U.S. Application Data
(60) Provisional application No. 63/334,661, filed on Apr. 25, 2022.
(60) Provisional application No. 63/335,690, filed on Apr. 27, 2022.
(60) Provisional application No. 63/344,010, filed on May 19, 2022.
(60) Provisional application No. 63/454,014, filed on Mar. 22, 2023.

(51) Int. Cl. H01M 4/62; H01G 11/06; H01G 11/24; H01G 11/32; H01G 11/50; H01G 11/56; H01M 4/02; H01M 50/414; H01M 50/46; H01M 50/497

(52) U.S. Cl. CPC H01M 4/625; H01G 11/06; H01G 11/24; H01G 11/32; H01G 11/50; H01G 11/56; H01M 4/626; H01M 50/414; H01M 50/46; H01M 50/497; H01M 2004/021; H01M 2004/027; H01M 2004/028

(57) ABSTRACT

An embedded electrode assembly (EMELA), comprising a substrate capable of conducting or storing a charge, wherein said substrate comprises one of a plurality of pores, a network of interconnected empty volumes, or an array of a plurality of pores extending into the substrate and a continuous conductive particle network (CCPN) comprising a plurality of conductive particles, wherein the conductive particles are dispersed within the pores or the interconnected empty volumes of the substrate.

### TECHNICAL FIELD

The present disclosure relates to nano- or micro-energy devices and related methods.

### INTRODUCTION

Developments in environmental friendlier and renewable energy systems reducing the dependence on fossil fuels are essential due to the continuous increase on world energy consumption, environmental impacts and, in particular, CO2 emission. The overall approach to building electronics components such as batteries and capacitors has not changed since their first invention around 18^{th} and 19^{th} century. In particular, for the case of capacitors and batteries, the improvements have mostly focused on the use of different materials for the electrodes, or anodes and cathodes. In particular, the overall structure of capacitors involves two electrodes separated by a dielectric material. For batteries, a cathode and anode is separated by a gap filled with an electrolyte material. There is an additional salt bridge that allows controlled diffusion of ions and often a separator for prevention of short circuits. The improvement of batteries has typically involved improving the energy density of the anode and cathode. Other developments include improvement of electrolyte material, improvement of chemistry mainly focused on the type of charge carrying ions. For capacitors, charge capacity of electrodes has been improved and the distance between the electrodes has been reduced to improve the electric field produced in between electrodes. Super capacitors have been developed, which allows the generation of an electric field between the electrode and double layer in solution, which essentially reduces the effective distance dramatically.

However, these approaches are not sufficient to address the need for higher capacity. Lithium has the highest electrochemical potential of all metals and highest energy density of all potential battery materials. However, electrochemical plating of lithium is known to generate dendrites that: reduce the efficiency, can short the battery, prevents safe operation of the cell, and can even cause a violent explosion.

Current solutions to this problem include attempts at slowing down the recharging rate, inclusion of additives to the electrolyte, and addition of mechanisms to turn off cells when they exceed certain temperatures. These all increase the size, weight, and complexity of the energy devices, e.g., batteries and capacitors, and thus reduces their practicality.

In the case of batteries, current approaches use anodes and cathodes that have a very high surface area due to their porosity and thus, high energy content. However, the ions still need to pass through electrolyte medium with limited diffusion and have separators that aim to prevent potential shorts between the anode and cathode. If the ions accumulate too fast and if they don't have time to settle and find allocated spots on the counter electrode, certain unwanted effects are observed, such as, e.g., the formation of dendrites in the case of lithium being used. These dendrites are structures that stick out of the surface and can short the anode and cathode, causing hazards such as, for example, an exothermic chain reaction resulting in an explosion. Although the surface areas of anodes and cathodes have improved over time, the electrolyte has not been improved, thus limiting the overall performance of the battery.

In the case of capacitors, having a very porous electrode structure (which is typically the main area for improvement) does not help much because what matters most is the distance between the two electrodes. However, having an essentially thicker electrode would end up producing a longer distance between the two extremes of the electrodes, thereby reducing the electric field magnitude that reduces the amount of charge stored within the electric field.

In short, for energy storage, very high surface areas of electrodes are important; charge and discharge rates must be fast; safety is a big concern (i.e. Samsung Galaxy Note 7 incident); current batteries have very high energy density but slow charge/discharge; Li-ion batteries pose fire hazards; lithium ion batteries have high surface area cathodes, however, they need to limit the electrolyte ionic fluid flow because of fire hazard; capacitors have much faster charge and discharge but have low energy density; ultracapacitors have much higher energy density compared to capacitors but low voltage is a limitation because of a double layer, therefore they cannot reach a battery's energy capacity; and both ultracapacitors and lithium ion batteries have voltage limits although high voltage is always desirable for storage applications.

Modern lithium ion battery technologies provide the highest energy density due to light lithium ion. Dendritic growth is one of the limiting factors. In ion current densities within the cell exceeding 6 mA/cm2 accelerates the dendritic growth, leading the shorts and structural faults. Shorts can cause fires. The structural defects due to such growth shortens the life span of the battery and rapid decaying of performance over time.

FIG. 1 includes diagrams 110, 120, 130, 140, and 150, illustrating dendrite growth in conventional batteries at different current densities associated with different charging rates. For example, at a charging and/or discharging rate of 1 C (a full charge and/or discharge in 1 hour) an electrolyte (e.g., ionic) current density often exceeds 6 mA/cm² which is considered to be an upper limit of acceptable electrolyte current density. While dendrite growth may occur at smaller current densities, the rate of dendrite growth increases non-linearly with increasing electrolyte current density in some applications with 6 mA/cm² being considered an upper limit for acceptable current density as it may lead to catastrophic dendrite formation.

The other issue is the limited ion conductivity of materials, in particular, in the separator side. Usually, the separator thickness in the orders of tens of microns. Solid state batteries have been explored to improve the energy density. However, poor ionic conductivity of solid-state components reduces the battery performance dramatically, reducing the applicability.

Lithium anode batteries and silicon anode batteries have been proposed. Lithium anode batteries provides very high energy density however, they suffer greatly from dendritic growth and the strategies to reduce dendritic growth often also reduce ionic conductivity, rendering lithium anode batteries still not feasible. Silicon offers very high energy density compared to graphite and more stability than lithium, however silicon anode batteries suffer from degradation issues in conventional geometries, e.g., due to high volume changes during charging and discharging operations and the compatible materials suffer from low ionic conductivity.

Accordingly, new devices, as well as methods of using and methods of making energy devices are needed. Presented herein is an approach that allows improving both the number of charge carriers and the potential difference dramatically while reducing the ion current density (especially important for lithium ion based battery technologies) leading to improvements that may cause a paradigm shift in energy storage. Presented herein is a game-changing nano-manufacturing approach for electronic and electrochemical rechargeable energy storage devices applicable to capacitors, super capacitors, and batteries and may be used for several different applications/markets. In some aspects, the new devices, as well as methods of using and methods of making energy devices provide 10-50 times more energy storage density, 100-2000 times faster charging rates, and/or 10-100 time longer life (number of charging cycles over a device lifetime).

### SUMMARY

Provided herein is an embedded electrode assembly (EMELA). In some embodiments, the EMELA may comprise:
a porous conductive substrate (PCS) capable of conducting or storing a charge, wherein said substrate comprises a plurality of pores, and
a continuous conductive particle network (CCPN) comprising a plurality of conductive particles, wherein the conductive particles are dispersed within the pores of the porous conductive substrate, wherein substantially all of the plurality of particles are in direct contact with two or more particles of the plurality of particles forming a continuous particle network.

In a particular embodiment of the EMELA, the porous conductive substrate is coated with, or comprises, a separator layer (e.g., a non-electrically conductive separator layer). In an additional embodiment, of the EMELA the porous conductive substrate comprises a non-conductive surface layer between the conductive surface layer and the continuous particle network. In another embodiment, the EMELA further comprises a first and second terminal, wherein the first terminal is attached to the porous conductive substrate and the second terminal is attached to the continuous particle network. In a further embodiment, the terminals are part of a composite-device. In some embodiments, the composite-device is a composite-nanobattery or a composite nano-capacitor.

In some embodiments, the EMELA may comprise:
a continuous conductive substrate (CCS) comprising a network of interconnected empty volumes, wherein said (CCS) is capable of conducting or storing a charge; and
a CCPN comprising a plurality of conductive particles, wherein the conductive particles are embedded within the network of interconnected empty volumes of the CCS.

In another embodiment, provided is an EMELA, comprising:
a porous medium (PM) capable of conducting or storing a charge, wherein said substrate comprises a plurality of pores, and
a CCPN comprising a plurality of particles, wherein the particles are dispersed within the pores of the porous medium, wherein substantially all of the plurality of particles are in direct contact with two or more particles of the plurality of particles forming a continuous particle network.

In another embodiment, provided is an EMELA, comprising:
a deep-pore-array (or deep hole array) silicon substrate (DPASS) capable of conducting or storing a charge, wherein the DPASS comprises an array of a plurality of pores extending into the DPASS, and
a CCPN comprising a plurality of particles, wherein particles of the plurality of particles are dispersed within the plurality of pores of the DPASS.

In a particular embodiment, the empty volumes of the CCS (or the material of the CCS surrounding the empty volumes) and/or pores of the PCS, the PM, or the DPASS are coated with a separator layer. In some embodiments of the EMELA, the separator layer may be a non-electrically conductive separator layer that may further be conductive for ions (e.g., electrically non-conductive and ionically conductive). In particular embodiments, the separator layer has a thickness of 0.1 to 100 nanometers. In some embodiments, the separator layer has a thickness of 100 nanometers to 10 microns and may have a thickness of approximately 1 micron.

In an embodiment, the PCS, the CCS, the PM, or the DPASS comprises a single type of material selected from silicon or carbon, or the like. In yet another embodiment, the PCS, the CCS, the PM, or the DPASS comprises a plurality of types of particles (or materials) selected from silicon, carbon, a binder material, and the like. In certain embodiments, the plurality of particles in the CCPN are in submicron scale (e.g., have a diameter below 1 micron, such as between 1 nm and 900 nm or between 1 nm and 500 nm). In other embodiments, the plurality of particles in the CCPN are in micron scale (are between 0.5 and 500 microns, or between 0.5 and 5 microns in diameter). While the particles of the CCPN referenced above may have a characteristic scale that is one of a submicron scale or a micron scale, for convenience they are referred to generally/collectively as particles in the discussion below. In some embodiments, the scale of the particles of the CCPN may be based on a scale of the pores or empty volumes of the PCS, the CCS, the PM, or the DPASS.

In some embodiments, substantially all of the plurality of particles are in direct contact with two or more particles of the plurality of particles forming the CCPN. The EMELA, in some embodiments, may further comprise an anodic component electrically separate from the CCPN and electrically connected to the PCS, the CCS, the PM, or the DPASS. In some embodiments, the anodic component comprises an anodic current collector. The EMELA, in some embodiments, further comprises a cathodic component electrically separate from the PCS, the CCS, or the PM and electrically connected to the CCPN. The cathodic component, in some embodiments, comprises a cathodic current collector. In some aspects, the anodic/cathodic current collectors may be referred to as terminals or contacts and may be made of a metal or alloy. The particular metals and/or alloys may be selected based on electronic characteristics of the metals and/or alloys and desired characteristics (e.g., charged voltage) of a composite device including the EMELA.

The EMELA, in some embodiments, further comprises an electrolyte material comprising a medium for a transfer of ions between the CCPN and one of the PCS, the CCS, the PM, or the DPASS. The electrolyte material may fill interstices between the CCPN and the PCS, the CCS, the PM, or the DPASS and promote the transfer of ions between the CCPN and the PCS, the CCS, the PM, or the DPASS. In some aspects, the electrolyte material comprises a solvent and a solute. In other embodiments, the electrolyte material comprises a solid state electrolyte material. The solid state electrolyte material, in some embodiments, is a conductor for the ions and an insulator for electrons. In some aspects, the separator may comprise the solid state electrolyte material, e.g., the solid state electrolyte material may serve as the separator as described above.

In some embodiments of the EMELA, the PCS, the CCS, the PM, or the DPASS comprises a silicon-based substrate (e.g., a silicon deep-pore array as discussed in relation to FIGS. 14-18 below, a porous silicon structure as discussed in relation to FIGS. 2 and 3, or silicon nanowires as discussed in relation to FIG. 4, panel 1, or other similar structures) and the CCPN comprises a lithium-based (micro- or nano-) particle (or lithium-based particle slurry). In certain embodiments of the invention, the PCS, the CCS, the PM, or the DPASS comprises a material selected from the group consisting of one or more of: Carbon, Copper Carbon, Copper Chloride, Copper Sulfide, Copper (II) Oxide, Graphene, Graphene Oxide Monolayer, Graphite, Manganese Selenide, Potassium Graphite, Pyrolytic Graphite, Silicon, Tin Oxide, Lithium metal, and/or Zinc. In some aspects, a silicon (or other semiconductor) substrate may be doped with one or more additional materials to form “doped silicon” or “doped substrate” (e.g., elements such as boron or gallium for p-type doping and/or elements such as arsenic or phosphorous for n-type doping) to affect electrical characteristics, for example, to increase conductivity of the substrate.

The PCS, the CCS, or the PM, in some embodiments, comprises a carbon-based substrate and the CCPN comprises a lithium-based particle. In certain embodiments of the invention, the CCPN comprises a material selected from the group consisting of one or more of: Bismuth Trioxide, Cobalt Oxide Particles, Iron Disulfide, Lithium Aluminum Alloy, Lithium Carbonate, Lithium Cobalt Oxide, Lithium Cobalt Phosphate, Lithium Hydroxide, Lithium Hydroxide, Lithium Iron Phosphate (LFP), Lithium Iron (III) Oxide, Lithium Manganese Dioxide, Lithium Manganese Nickel Oxide (LMNO), Lithium Manganese Oxide (LMO), Lithium Molybdate, Lithium Nickel Cobalt Aluminum Oxide, Lithium Nickel Cobalt Oxide, Lithium Nickel Dioxide, Lithium Nickel Manganese Cobalt Oxide (NMC), Lithium Silicon Alloy, Lithium Tin Alloy, Lithium Titanate, Lithium Titanate Spinel, Manganese (IV) Oxide, Nickel Hydroxide, Silver Chromate, Silver Oxide, and/or Vanadium Pentoxide.

In some embodiments, an electrically non-conductive and ionically conductive separator layer (e.g., a separator layer that does not conduct electrons, or allow electrons to pass, between the CCPN to the PCS, the CCS, the PM, or the DPASS, but does conduct ions, or allow ions to pass, between the CCPN to the PCS, the CCS, the PM, or the DPASS) is interposed between the PCS, the CCS, the PM, or the DPASS and the CCPN. The non-conductive separator layer, in some embodiments, is an oxide layer formed on the surface of the PCS, the CCS, the PM, or the DPASS. In some embodiments, the separator layer is deposited (e.g., grown, applied, etc.) on the surface of the PCS, the CCS, the PM, or the DPASS. The separator layer, in some embodiments, is a polymer layer.

In particular embodiments, the separator layer is non-planar and coats and/or envelops substantially the entire surface area of the PCS, the CCS, the PM, or the DPASS. In another embodiment, the separator layer coats and/or envelopes the entire surface area of the PCS, the CCS, the PM, or the DPASS. Accordingly, in particular embodiments, the separator layer conforms to whatever 3-dimensional shape and/or dimension is formed by the PCS, the CCS, the PM, or the DPASS. In another embodiment, the separator layer gloves the PCS, the CCS, the PM, or the DPASS.

In another embodiment, it is contemplated herein the separator layer can coat and/or envelope the CCPN in order to provide the separator layer interposed between the PCS, the CCS, the PM, or the DPASS and the CCPN within the inventive EMELA.

In some aspects, a characteristic size (e.g., an average diameter) of the empty volumes (or pores) that comprise the interconnected empty volumes (or the array of the plurality of pores) is less than one of 100, 90, 80, 70, 60, 50, 40, 30, 20, 10, 9, 8, 7, 6, 5, 4, 3, 2, or 1 micrometers. In some aspects, a characteristic size of the empty volumes (or pores) that comprise the interconnected empty volumes (or the array of the plurality of pores) is less than one of 900, 800, 700, 600, 500, 400, 300, 200, 100, 90, 80, 70, 60, 50, 40, 30, 20, 10, 9, 8, 7, 6, 5, 4, 3, 2, or 1 nanometers. The characteristic size may be associated with a ratio between a volume associated with the interconnected empty volumes (or pores) and a surface area associated with the interconnected empty volumes (or pores). In some aspects, the characteristic size may be associated with a ratio between a volume of a composite device comprising the EMELA and a surface area between the PCS, the CCS, the PM, or the DPASS and the CCPN.

In some embodiments, a characteristic size of the conductive particles, e.g., a radius (for example, a largest radius, an average radius, etc.) or a ratio between a volume associated with the conductive particles and a surface area of the conductive particles (e.g., a specific surface area), is less than the characteristic size of the pores or the characteristic size of the interconnected empty volumes (e.g., a characteristic size of the empty volumes that comprise the interconnected empty volumes). The characteristic size of the conductive particles, in some embodiments, is less than one of 90%, 80%, 70%, 60%, 50%, 40%, 30%, 20%, 10%, 9%, 8%, 7%, 6%, 5%, 4%, 3%, 2%, or 1% of the characteristic size of the empty volumes (e.g., the pores or interconnected empty volumes). For example, a specific surface area, or an average radius, of the conductive particles may be one of 10, 9, 8, 7, 6, 5, 4, 3, 2, or 1 micrometers⁻¹, or micrometers, respectively or 900, 800, 700, 600, 500, 400, 300, 200, 100, 90, 80, 70, 60, 50, 40, 30, 20, 10, 9, 8, 7, 6, 5, 4, 3, 2, or 1 nanometers⁻¹, or nanometers, respectively. In some embodiments, a standard deviation of the size of the conductive particles is one or more of 1%, 3%, 5%, 10%, 15%, 20%, 25%, 30%, 35%, 40%, 45%, and/or 50% of the characteristic size of the conductive particles.

In some embodiments, an average ionic diffusion distance for ions diffusing from the CCPN to the PCS, the CCS, the PM, or the DPASS (e.g., during a charging operation), or vice versa (e.g., from the PCS, the CCS, the PM, or the DPASS to the CCPN), is less than one of 100, 90, 80, 70, 60, 50, 40, 30, 20, 10, 9, 8, 7, 6, 5, 4, 2, and/or 1 micrometers. In some embodiments, an average distance from any point within the CCPN to a closest point within the PCS, the CCS, the PM, or the DPASS, or from a point in the PCS, the CCS, the PM, or the DPASS to a closest point in the CCPN, is less than one of 100, 90, 80, 70, 60, 50, 40, 30, 20, 10, 9, 8, 7, 6, 5, 4, 2, and/or 1 micrometers. In some aspects, the average ionic diffusion distance may be controlled by the size of the pores (or empty volumes).

In some embodiments, an average ionic diffusion distance (e.g., during a charging operation) for ions diffusing from the CCPN to the PCS, the CCS, the PM, or the DPASS (or vice versa for a discharging operation), is less than one of 900, 800, 700, 600, 500, 400, 300, 200, 100, 90, 80, 70, 60, 50, 40, 30, 20, 10, 9, 8, 7, 6, 5, 4, 3, 2, or 1 nanometers. In some embodiments, an average distance from any point within the CCPN to a closest point within the PCS, the CCS, the PM, or the DPASS, or from a point in the PCS, the CCS, the PM, or the DPASS to a closest point in the CCPN, is less than one of 900, 800, 700, 600, 500, 400, 300, 200, 100, 90, 80, 70, 60, 50, 40, 30, 20, 10, 9, 8, 7, 6, 5, 4, 3, 2, or 1 nanometers. In some embodiments, a charging (or discharging) operation comprises one of a multidirectional flow of ions from the CCPN to the PCS, the CCS, the PM, or the DPASS or an omnidirectional flow of ions from the CCPN to the PCS, the CCS, the PM, or the DPASS.

In some embodiments, the average ionic diffusion distance may be based on an average distance traveled by ions diffusing from the CCPN until entering the material of the PCS, the CCS, the PM, or the DPASS, or vice versa (e.g., from the PCS, the CCS, the PM, or the DPASS to the CCPN) during a charging or discharging operation. The average ionic diffusion distance, in some aspects, is less than one of 100, 90, 80, 70, 60, 50, 40, 30, 20, 10, 9, 8, 7, 6, 5, 4, 2, and/or 1 micrometers. In some embodiments, an average distance from any point within the CCPN to a closest point within the PCS, the CCS, the PM, or the DPASS, or from a point in the PCS, the CCS, the PM, or the DPASS to a closest point in the CCPN, is less than one of 100, 90, 80, 70, 60, 50, 40, 30, 20, 10, 9, 8, 7, 6, 5, 4, 2, and/or 1 micrometers.

The EMELA, in some embodiments, further comprises a first and second terminal, wherein the first terminal is attached to the PCS, the CCS, the PM, or the DPASS and the second terminal is attached to the CCPN. In some embodiments, the terminals are part of a composite-device. The composite-device, in some aspects, may be a composite battery (e.g., a composite-nanobattery or composite-microbattery) or a composite capacitor (e.g., a composite nano-capacitor or composite micro-capacitor).

In some embodiments, the composite-device, e.g., the composite-nanobattery or a composite nano-capacitor comprising the EMELA, is capable of being charged from 10 percent to 90 percent in less than one of one hour, 45 minutes, 30 minutes, 10 minutes, 1 minute, 45 seconds, 30 seconds, 10 seconds, 5 seconds, 1 second, 0.1 second, 1×10⁻² seconds, 1×10⁻³ seconds, 1×10⁻⁴ seconds, 1×10⁻⁵ seconds, and/or 1×10⁻⁶ seconds. The EMELA (or a composite device comprising the EMELA), in some aspects, is capable of being charged at a rate of 1 C, 2 C, 3 C, 4 C, 5 C, 6 C, 7 C, 8 C, 9 C, 10 C, 15 C, 20 C, 25 C, 30 C, 40 C, 50 C, 60 C, 70 C, 80 C, 90 C, 100 C, 200 C, 500 C, 1000 C, 2000 C, 5000 C, 10×10³ C, and/or 10×10⁴ C while an ion current density throughout the composite-device is below 6 mA/cm². In some embodiments, the composite-device is capable of being charged and discharged for at least one of 1×10³, 5×10³, 1×10⁴, 5×10⁴, 1×10⁵, 5×10⁵, 1×10⁶, 5×10⁶, 1×10⁷, 5×10⁷, 1×10⁸, 5×10⁸, and/or 1×10⁹ cycles before breakdown, wherein a breakdown comprises an uncontrolled discharge of energy. In some embodiments, the composite-device is capable of being charged and discharged for at least one of 1×10³, 5×10³, 1×10⁴, 5×10⁴, 1×10⁵, 5×10⁵, 1×10⁶, 5×10⁶, 1×10⁷, 5×10⁷, 1×10⁸, 5×10⁸, and/or 1×10⁹ cycles while achieving at least 80 percent of an initial charge.

In some embodiments, a ratio between a surface area of an interface between the PCS, the CCS, the PM, or the DPASS (e.g., the substrate) and the CCPN and a volume of the EMELA is greater than 50 cm⁻¹, 100 cm⁻¹, 200 cm⁻¹, 500 cm⁻¹, 1000 cm⁻¹, 5000 cm⁻¹, 1×10⁴ cm⁻¹, 5×10⁴ cm⁻¹, 1×10⁵ cm⁻¹, 1×10⁶ cm⁻¹, 1×10⁷ cm⁻¹, 1×10⁸ cm⁻¹. In some aspects, the surface area of the interface may be equivalent to the surface area of the substrate (e.g., the PCS, the CCS, the PM, or the DPASS) or the CCPN. In some aspects, the surface area of the interface may be based on an area of contact between the substrate and the CCPN, where the contact may be defined by having the substrate and CCPN being within a threshold distance of each other across which ion transfer is possible. The surface area of the interface between the substrate and the CCPN, in some aspects, may be defined as the surface area of the substrate that participates in ion transfer between the substrate and the CCPN (e.g., directly or via an electrolyte associated with the CCPN and/or the substrate).

The empty volumes (or pores) of the PCS, the CCS, the PM, or the DPASS, in some embodiments, comprise one or more of 1%, 5%, 10%, 15%, 20%, 25%, 30%, 35%, 40%, 45%, 50%, 55%, 60%, 65%, 70%, 75%, 80%, 85%, and/or 90% unfilled volume before the conductive particles are embedded within the network of interconnected empty volumes or within the pores of the PCS, the CCS, the PM, or the DPASS. The empty volumes (or pores) of the PCS, the CCS, the PM, or the DPASS, in some embodiments, comprise one or more of 1%, 5%, 10%, 15%, 20%, 25%, 30%, 35%, 40%, 45%, and/or 50% unfilled volume after the conductive particles are embedded within the network of interconnected empty volumes or within the pores of the PCS, the CCS, the PM, or the DPASS. For example, the unfilled volume of the PCS, the CCS, the PM, of the DPASS, may be related to a mean bulk density of the CCPN after being embedded in the empty volumes (or pores) of the PCS, the CCS, the PM, of the DPASS. In some embodiments, the empty volume accommodates expansion of the PCS, the CCS, the PM, or the DPASS during a charging operation.

In some embodiments, a gravimetric energy density of the EMELA (or a composite device including the EMELA) is greater than one of 300, 1000, 2000, 5000, 10×10³, and/or 20×10³ Wh/Kg. The power density of the EMELA is greater than at least one of 300, 500, 1000, 2000, 3000, 4000, 5000, 6000, 7000, 8000, 9000, 10×10³, and/or 20×10³ W/Kg. In some embodiments, a volumetric energy density of the EMELA (or a composite device including the EMELA) is greater than at least one of 5, 10, 15, 20, 30, 40, and/or 50 MJ/L.

The inventive Embedded Electrode Assembly provided herein improves the surface area dramatically (e.g., by one or more orders of magnitude in some aspects), which reduces the ion current density within the cell.

This results, in some aspects, in extremely low dendritic formation. At the same time, the distance for ion diffusion, in some aspects, also decreases one or more orders of magnitude. This reduced distance allows use of materials that improve one or more aspects of the battery chemistry despite the materials having low ionic conductivity.

In a particular embodiment of the inventive EMELA, the anode and the cathode are embedded with each other (e.g., in the form of a continuous particle network (e.g., the CCPN) embedded within the PCS, the CCS, the PM, of the DPASS). For example, FIG. 2 illustrates a porous silicon substrate 210 that comprises a continuous conductive substrate comprising a network of interconnected empty volumes 215. FIG. 3 further illustrates a zoomed-in view of an interface between the continuous conductive particle network 230/330 and the continuous conductive substrate 210/310. As depicted in FIGS. 2 and 3, in some embodiments, a thin protective layer 220 and/or 320 around the porous conductive substrate, functioning in this embodiment as the anode, acts as a separator layer between (see FIG. 3, bottom panel). As an advantageous result, the typical distance of ion diffusion length is reduced down to tens of nanometers instead of tens (or hundreds) of microns, providing more than 1000-fold gain in the ionic conductivity. In some embodiments, the increase in surface area may be increased or decreased to achieve other benefits. Acceptable tradeoffs in some embodiments may be reflected in table 1200 of FIG. 12.

FIG. 7 illustrates an embodiment in which the continuous conductive particle network (e.g., CCPN 230/330) and/or the continuous conductive substrate (e.g., the PCS, the CCS, or the PM 210/310) may include multiple types of particles, such that one or both of the CCPN and/or the PCS, the CCS, or the PM (or the DPASS in other embodiments) are composites of different materials. For example, FIG. 7 illustrates that, in some embodiments, the CCPN includes a cathode particle 725, and an additive particle (e.g., a carbon particle 735) or substance (e.g., a binder such as a polymer). FIG. 7 also illustrates that in some embodiments the PCS, the CCS, or the PM (or the DPASS in other embodiments) includes an anode particle (e.g., silicon particle 705) and an additive particle (e.g., carbon particle 715) (e.g., a primary anode material and a dopant material or element in embodiments using a DPASS).

The additional materials (e.g., particles, binders, etc.) might include additives to improve conductivity such as carbon nano/micro particles and binder materials to provide structural integrity. such as polytetrafluoroethylene (PTFE), polyvinylidene fluoride (PVDF), styrene butadiene rubber (SBR), or carboxymethyl cellulose. For example, PVDF (Polyvinylidene Fluoride) is routinely adopted in the traditional Li-ion cell manufacturing process for making cathode and anode slurry. In other embodiments for making cathode and anode slurry, aqueous base materials can be use, such as SBR copolymers, more specifically Modified SBR (Styrene Butadiene Copolymer) Hydrophilic binders (available from Targray, Kirkland QC, Canada). In yet other embodiments, high speed thick electrode electron beam curing that involves dry binders, can be used herein for making cathode and anode slurry (see, e.g, Du, et al., “High-Speed electron beam curing of thick electrode for high energy density Li-ion batteries,” Green Energy & Environment, Volume 4, Issue 4, 2019, Pages 375-381, ISSN 2468-0257; which is incorporated herein by reference in its entirety for all purposes).

Panel 1 of FIG. 7 illustrates that a porous conductive substrate or a continuous conductive substrate (e.g., a porous anode) may be formed by first mixing carbon and silicon particles, or the like, suspended in a solvent. Panel 2 of FIG. 7 illustrates that the solvent may be washed and/or removed (dried or evaporated) to form a porous layer. The porous layers may be fused to each other after removing the solvent using a heat treatment. Panel 3 of FIG. 7 illustrates growing a nano/micro separator layer 720, e.g., by sol-gel methods, and/or a silicon carbide layer onto the porous conductive substrate or continuous conductive substrate to stabilize the structure and act as a separator. Next, a cathode slurry that may include additives such as carbon particles to improve conductivity, a binder material to provide structural integrity, or other additives to improve other characteristics of the CCPN, may be added to fill the pores of the anode composite as illustrated in panel 4 o FIG. 7.

The surface area of the porous and/or continuous conductive substrate also improves more than 1000-fold. Increasing the surface area reduces the ion current density by a comparable magnitude for a same charging rate of the composite device 240 when compared to a standard battery or capacitor, e.g., a battery or capacitor with non-embedded/interlocking anode and cathode structures. For example, FIG. 8 illustrates a side by side comparison of a standard battery geometry 801 and an EMELA battery geometry 802. The porous conductive substrate structure is porous, which, in some aspects, provides space for dramatic size changes without generating structural defects to the overall inventive embedded electrode assembly (EMELA) (See FIG. 2, panels 1 and 2).

Accordingly, the following Items are provided:
1. An embedded electrode assembly (EMELA), comprising:
   a porous conductive substrate (PCS) capable of conducting or storing a charge, wherein said substrate comprises a plurality of pores;
   a continuous conductive particle network (CCPN) comprising a plurality of conductive particles, wherein conductive particles of the plurality of conductive particles are dispersed within the plurality of pores of the porous conductive substrate; and
   a non-electrically-conductive separator layer interposed between the PCS and the CCPN.
2. An embedded electrode assembly (EMELA), comprising:
   a continuous conductive substrate (CCS) comprising a network of interconnected empty volumes, wherein said CCS is capable of conducting or storing a charge;
   a continuous conductive particle network (CCPN) comprising a plurality of conductive particles, wherein conductive particles of the plurality of conductive particles are embedded within the network of interconnected empty volumes of the CCS; and
   a non-electrically-conductive separator layer interposed between the CCS and the CCPN.
3. An embedded electrode assembly (EMELA), comprising:
   a substrate comprising a porous medium (PM) capable of conducting or storing a charge, wherein the PM comprises a plurality of pores,
   a continuous conductive particle network (CCPN) comprising a plurality of particles, wherein particles of the plurality of particles are dispersed within the plurality of pores of the porous medium; and
   a non-electrically-conductive separator layer interposed between the PM and the CCPN.
4. An embedded electrode assembly (EMELA), comprising:
   a deep-pore-array silicon substrate (DPASS) capable of conducting or storing a charge, wherein the DPASS comprises an array of a plurality of pores extending into the DPASS,
   a continuous conductive particle network (CCPN) comprising a plurality of particles, wherein particles of the plurality of particles are dispersed within the plurality of pores of the DPASS; and
   a non-electrically-conductive separator layer interposed between the DPASS and the CCPN.
5. The EMELA of any one of items 1-4, wherein substantially all of the plurality of particles are in direct contact with two or more particles of the plurality of particles forming the CCPN.
6. The EMELA of any one of items 1-5, further comprising an anodic component electrically separate from the CCPN and electrically connected to the substrate.
7. The EMELA of item 6, wherein the anodic component comprises an anodic current collector.
8. The EMELA of any one of items 1-7, further comprising a cathodic component electrically separate from the substrate, and electrically connected to the CCPN.
9. The EMELA of item 8, wherein the cathodic component comprises a cathodic current collector.
10. The EMELA of any one of items 1-9, further comprising an electrolyte material comprising a medium for a transfer of ions between the CCPN and the substrate.
11. The EMELA of item 10, wherein the electrolyte material comprises a solvent and a solute.
12. The EMELA of item 11, wherein the electrolyte material comprises a solid state electrolyte material, the solid state electrolyte material being a conductor for the ions and an insulator for electrons.
13. The EMELA of any one of items 1-12, wherein the substrate comprises a silicon-based substrate and the CCPN comprises a lithium-based particle.
14. The EMELA of any one of items 1-12, wherein the substrate, comprises a carbon-based substrate and the CCPN, comprises a lithium-based particle.
15. The EMELA of any one of items 1-14, wherein the non-electrically-conductive separator layer is ionically conductive such that electrons cannot pass between the CCPN and the substrate and ions can pass between the CCPN and the substrate.
16. The EMELA of item 15, wherein the non-electrically-conductive separator layer has a thickness of one of 0.1 to 100 nm, 10 nm to 5 microns, or 10 nm to 10 microns.
17. The EMELA of item 15, wherein the non-electrically-conductive separator layer is an oxide layer formed on a surface of the substrate.
18. The EMELA of item 15, wherein the non-electrically-conductive separator layer is deposited on a surface of the substrate.
19. The EMELA of item 18, wherein the non-electrically-conductive separator layer is a polymer layer.
20. The EMELA of any one of items 1-19, wherein the EMELA is comprised in a composite-device comprising one of a composite-nanobattery or a composite nano-capacitor.
21. The EMELA of item 20, wherein a charging operation of the composite-device comprises at least one of a multidirectional flow of ions from the CCPN, to the substrate, or an omnidirectional flow of ions from the CCPN, to the substrate.
22. The EMELA of any one of items 1-21, wherein an average ionic diffusion distance for ions diffusing from the CCPN, to the substrate, is less than at least one of: 100 μm, 50 μm, 10 μm, 1 μm, 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 20 nm, 10 nm, 9 nm, 8 nm, 7 nm, 6 nm, 5 nm, 4 nm, 3 nm, 2 nm, or 1 nm.
23. The EMELA of any one of items 1-22, wherein a characteristic size of the network of interconnected empty volumes or the plurality of pores is less than at least one of: 100 μm, 50 μm, 10 μm, 1 μm, 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 20 nm, 10 nm, 9 nm, 8 nm, 7 nm, 6 nm, 5 nm, 4 nm, 3 nm, 2 nm, or 1 nm.
24. The EMELA of item 23, wherein a characteristic size of conductive particles in the plurality of conductive particles is less than one of: 90%, 80%, 70%, 60%, 50%, 40%, 30%, 20%, 10%, 9%, 8%, 7%, 6%, 5%, 4%, 3%, 2%, or 1% of the characteristic size of the network of interconnected empty volumes or the plurality of pores.
25. The EMELA of item 24, wherein a standard deviation of a size of conductive particles in the plurality of conductive particles is one of: 1%, 3%, 5%, 10%, 15%, 20%, 25%, 30%, 35%, 40%, 45%, or 50% of the characteristic size of the conductive particles in the plurality of conductive particles.
26. The EMELA of item 20, wherein the composite-device is capable of being charged from 10 percent to 90 percent in less than at least one of: one hour, 45 minutes, 30 minutes, 10 minutes, 1 minute, 45 seconds, 30 seconds, 10 seconds, 5 seconds, 1 second, 0.1 second, 1×10⁻² seconds, 1×10⁻³ seconds, 1×10⁻⁴ seconds, 1×10⁻⁵ seconds, and/or 1×10⁻⁶ seconds.
27. The EMELA of any one of items 20 or 22-26, wherein the composite-device is capable of being charged and discharged for at least one of: 1×10³, 5×10³, 1×10⁴, 5×10⁴, 1×10⁵, 5×10⁵, 1×10⁶, 5×10⁶, 1×10⁷, 5×10⁷, 1×10⁸, 5×10⁸, and/or 1×10⁹ cycles before a breakdown.
28. The EMELA of item 27, wherein the breakdown comprises an uncontrolled discharge of energy.
29. The EMELA of any one of items 20 or 22-26, wherein the composite-device is capable of being charged and discharged for at least one of: 1×10³, 5×10³, 1×10⁴, 5×10⁴, 1×10⁵, 5×10⁵, 1×10⁶, 5×10⁶, 1×10⁷, 5×10⁷, 1×10⁸, 5×10⁸, and/or 1×10⁹ cycles while achieving at least one of 50%, 55%, 60%, 65%, 70%, 75%, 80%, 85%, 90%, or 95% of an initial charge.
30. The EMELA of any one of items 1-29, wherein an average distance from any point within the CCPN, to a closest point within the substrate, is less than at least one of: 100 μm, 50 μm, 10 μm, 1 μm, 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 20 nm, 10 nm, 9 nm, 8 nm, 7 nm, 6 nm, 5 nm, 4 nm, 3 nm, 2 nm, or 1 nm.
31. The EMELA of any one of items 1-30, wherein a ratio between a surface area of an interface between the substrate, and the CCPN, and a volume of the EMELA is greater than 200 cm⁻¹, 500 cm⁻¹, 1000 cm⁻¹, 5000 cm⁻¹, 1×10⁴ cm⁻¹, 5×10⁴ cm⁻¹, 1×10⁵ cm⁻¹, 1×10⁶ cm⁻¹, 1×10⁷ cm⁻¹, or 1×10⁸ cm⁻¹.
32. The EMELA of any one of items 1-31, wherein the substrate comprises one or more of: 1%, 5%, 10%, 15%, 20%, 25%, 30%, 35%, 40%, 45%, or 50% of unfilled volume after the conductive particles are embedded within the substrate.
33. The EMELA of item 32, wherein the unfilled volume accommodates expansion of the substrate, during a charging operation.
34. The EMELA of item 20, wherein a gravimetric energy density of the composite-device is greater than at least one of 300 Wh/Kg, 1000 Wh/Kg, 2000 Wh/Kg, 5000 Wh/Kg, 10×103 Wh/Kg, and/or 20×103 Wh/Kg.
35. The EMELA of item 20, wherein a power density of the composite-device is greater than at least one of 300 W/Kg, 500 W/Kg, 1000 W/Kg, 2000 W/Kg, 3000 W/Kg, 4000 W/Kg, 5000 W/Kg, 6000 W/Kg, 7000 W/Kg, 8000 W/Kg, 9000 W/Kg, 10×103 W/Kg, and/or 20×103 W/Kg.
36. The EMELA of item 20, wherein a volumetric energy density of the composite-device is greater than at least one of 5 MJ/L, 10 MJ/L, 15 MJ/L, 20, 30, 40, and/or 50 MJ/L.
37. The EMELA of any of items 1-4, wherein the substrate, comprises at least a first type of anode particle, or anode material, and a second additive component.
38. The EMELA of item 37, wherein the second additive component is one of an additive particle, ion, or element increasing a conductivity of the substrate, or a binder increasing a structural integrity of the substrate.
39. The EMELA of any of items 1-4, wherein the CCPN, comprises at least a first cathode particle type and a second additive component.
40. The EMELA of item 39, wherein the second additive component is one of an additive particle increasing a conductivity of the CCPN, or a binder increasing a structural integrity of the CCPN.
41. The EMELA of any one of items 1-4, wherein the substrate, comprises a doped silicon, wherein a doping of the doped silicon increases electrical conductivity of the doped silicon compared to an undoped silicon.
42. The EMELA of any one of item 1-41, wherein the non-electrically-conductive separator layer is selected from the group consisting of: 1,4-butanediol diglycidyl ether; Single-layer PE; Single-layer PP; Ceramic-coated PP; Trilayer PP/PE/PP; or the separator layers set forth in Tables 1-9.

### BRIEF DESCRIPTION OF THE DRAWINGS

FIG. 1 includes diagrams illustrating dendrite growth in conventional batteries at different current densities associated with different charging rates.

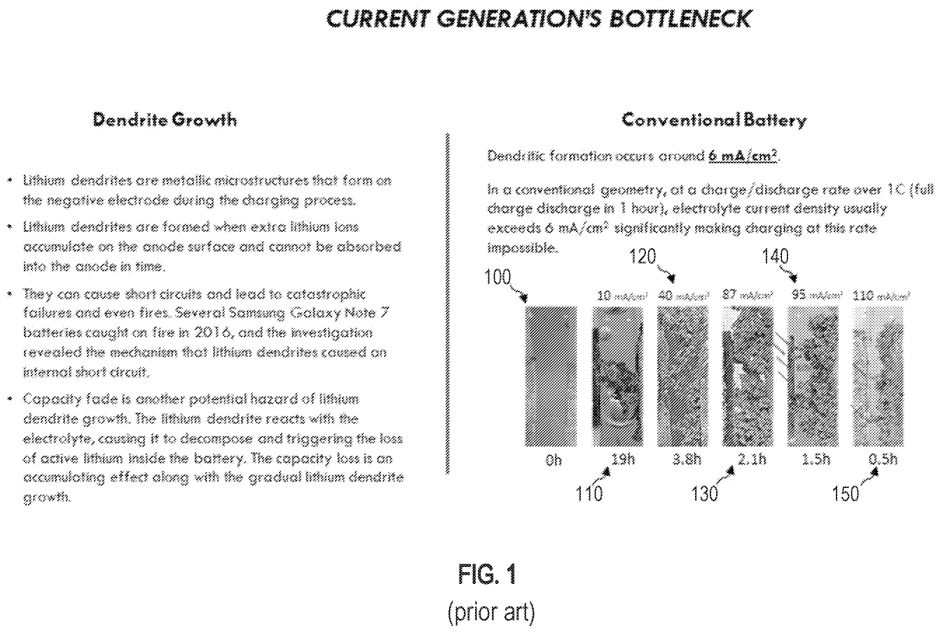

FIG. 2 illustrates components of an EMELA-based nano-device.

FIG. 3 further illustrates a zoomed-in view of an interface between the continuous conductive particle network and the continuous conductive substrate.

FIG. 4 illustrates components of a nano-structured EMELA-based nano-device.

FIG. 5 illustrates components of a composite device in accordance with some aspects of the disclosure.

FIG. 6 illustrates components of a composite device in accordance with some aspects of the disclosure.

FIG. 7 illustrates an embodiment in which the CCPN and/or the PCS, the CCS, or the PM may include multiple types of particle.

FIG. 8 includes a comparison of features of a first diagram relating to a conventional battery geometry and a second diagram relating to an EMELA battery geometry.

FIG. 9 illustrates a composite device utilizing the EMELA geometry including the cathode current collector, the cathode-only zone, the volume containing the EMELA structure, the anode-only zone and the anode current collector.

FIG. 10 illustrates a set of advantages of the EMELA geometry.

FIG. 11 illustrates a range of energy densities (Wh/Kg) and power densities (W/Kg) for different configurations (e.g., materials and geometries) of conventional batteries or capacitors.

FIG. 12 is a table of benefits and applications of the EMELA composite device.

FIG. 13 is a diagram illustrating additional aspects of dendritic growth.

FIG. 14 is a diagram illustrating a comparison between a standard battery structure and an EMELA battery structure using a deep array silicon substrate.

FIG. 15 is a diagram illustrating additional details of the EMELA battery structure illustrated in FIG. 14 in accordance with some aspects of the disclosure.

FIG. 16 is a diagram illustrating charging/discharging rates and ion current densities associated with a particular embodiment in accordance with some aspects of the disclosure.

FIG. 17 is a diagram illustrating additional details of the EMELA battery structure illustrated in FIGS. 14 and 15 in accordance with some aspects of the disclosure.

FIG. 18 is a diagram illustrating additional details of the EMELA battery structure illustrated in FIGS. 14, 15, and 17 in accordance with some aspects of the disclosure.

FIG. 19 is a method of manufacturing a composite nano-device in accordance with some aspects of the disclosure.

### DETAILED DESCRIPTION

As used herein, the phrase “composite-nanodevice” as used in the context of a composite-nanobattery, composite-nanocapacitor, composite-nanosolarcell, composite-nanoLED, composite-thermoelectric-device, or the like, refers to a composite-device that functions as a single electrical, conducting, or energy unit by virtue of the integration, in series and/or in parallel, of a plurality of individual particles within a nanowire-network, such that their individual energies or electrical or power or conductivity values are cumulative or added together and delivered from the overall composite-single-unit-device (e.g. a composite battery unit, a composite capacitor unit, a composite solar cell unit, a composite LED unit, and a composite thermoelectric unit). The number or volume of particles that can be combined in series (or in some embodiments in parallel) to form an inventive composite nanodevice (e.g., a composite nanobattery, and the like) can be selected from the group consisting of at least: 10⁶, 10⁷, 10⁸, 10⁹, 10¹⁰, 10¹¹, 10¹², 10¹³, 10¹⁴, 10¹⁵, 10¹⁶, 10¹⁷, 10¹⁸, 10¹⁹, 10²⁰, and at least 10²¹ particles.

In certain embodiments of the inventive composite-nanobattery-device, either a first plurality of particles or a porous conductive substrate may be configured as an electrode forming a cathode comprising particle material selected from the group consisting of one or more of: Bismuth Trioxide, Cobalt Oxide Particles, Iron Disulfide, Lithium Aluminum Alloy, Lithium Carbonate, Lithium Cobalt Oxide, Lithium Cobalt Phosphate, Lithium Hydroxide, Lithium Hydroxide, Lithium Iron Phosphate (LFP), Lithium Iron (III) Oxide, Lithium Manganese Dioxide, Lithium Manganese Nickel Oxide (LMNO), Lithium Manganese Oxide (LMO), Lithium Molybdate, Lithium Nickel Cobalt Aluminum Oxide, Lithium Nickel Cobalt Oxide, Lithium Nickel Dioxide, Lithium Nickel Manganese Cobalt Oxide (NMC), Lithium Silicon Alloy, Lithium Tin Alloy, Lithium Titanate, Lithium Titanate Spinel, Manganese (IV) Oxide, Nickel Hydroxide, Silver Chromate, Silver Oxide, and/or Vanadium Pentoxide.

In certain embodiments of the inventive composite-battery-device, a first plurality of particles or a porous conductive substrate may be configured as an electrode forming an anode comprising a particle material selected from the group consisting of one or more of: Carbon, Copper Carbon, Copper Chloride, Copper Sulfide, Copper (II) Oxide, Graphene, Graphene Oxide Monolayer, Graphite, Manganese Selenide, Potassium Graphite, Pyrolytic Graphite, Silicon, Tin Oxide, Lithium metal, and/or Zinc.

In particular embodiments, each composite-nano-device, can comprise a separator-layer comprising a material that is porous (e.g., to Lithium ions) and configured to allow ion diffusion. In some aspects, the separator layer (or separator-layer material) may be electrically non-conductive and ionically conductive (e.g., may not conduct electrons, or allow electrons to pass, between the CCPN and the PCS, the CCS, the PM, or the DPASS, but may conduct ions, or allow ions to pass, between the CCPN and the PCS, the CCS, the PM, or the DPASS)

In example embodiments of the inventive composite-nano-devices, such as the composite-battery-device or composite-nano-capacitor, the diameter of each nano-component (e.g., particle) is selected from the group consisting of: from about 1 nm to about 900 nanometers; from about 2 nm to about 500 nm; from about 3 nm to about 300 nm; from about 4 nm to about 200 nm; from about 5 nm to about 150 nm; from about 10 nm to about 150 nm; from about 15 nm to about 150 nm; from about 15 nm to about 100 nm; 20 nm to about 75 nm; from about 25 nm to about 50 nm. In other embodiments of the composite-nano-devices disclosed herein, such as, for example, the composite-battery-device, for each nano-device therein the dimension in any of a length, width, or depth direction of the core, or thickness for each of the separator layer and outer layer, are each selected from the group consisting of one or more of: 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, and 50 nm.

### Example 1

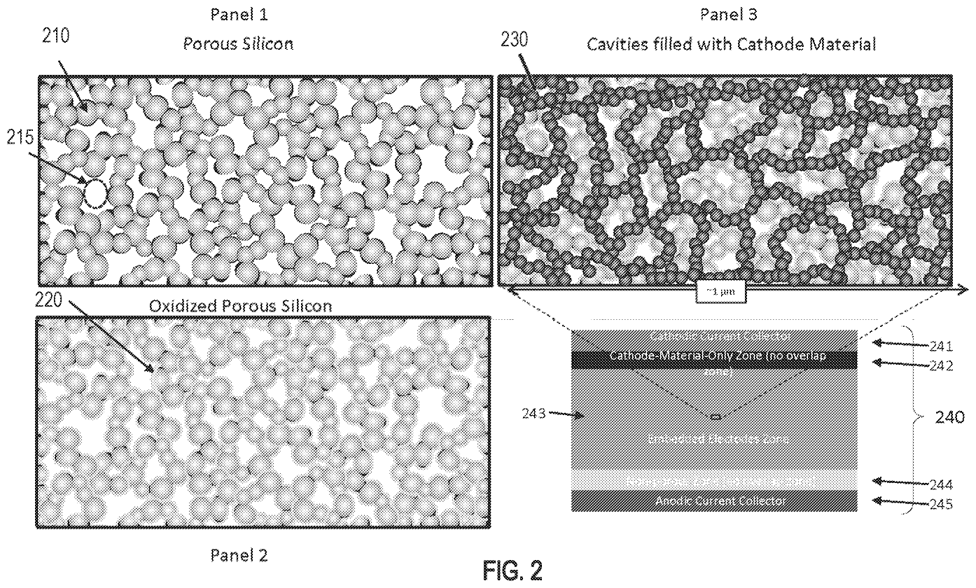

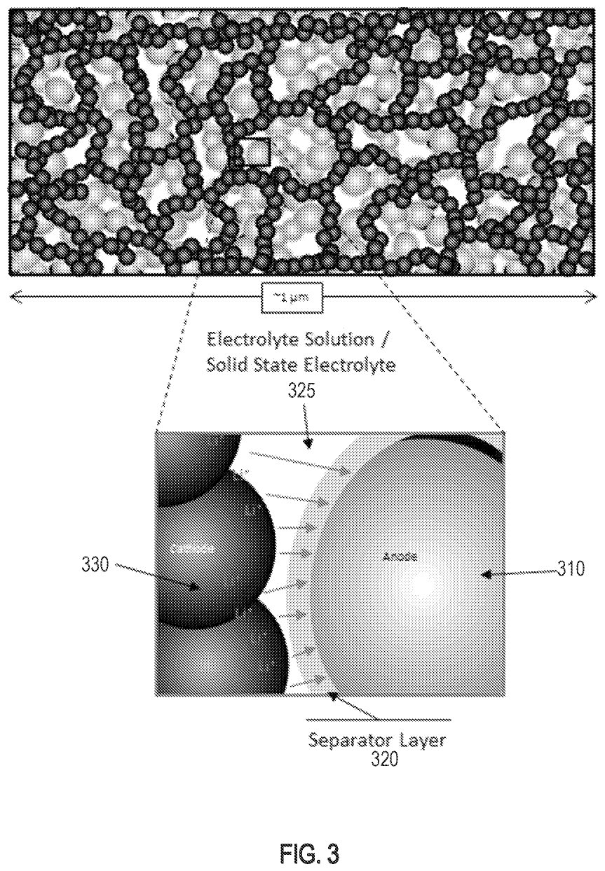

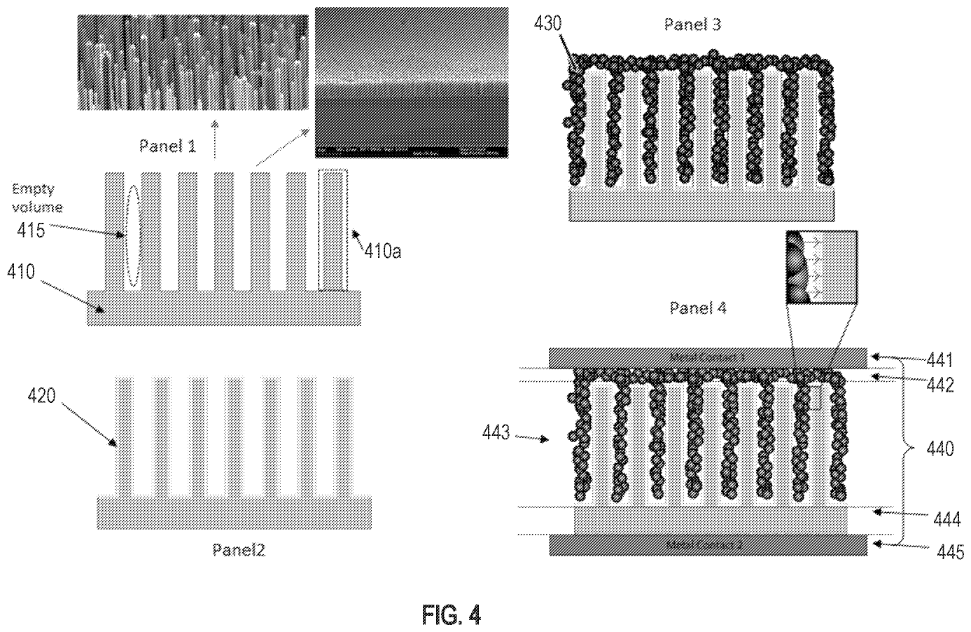

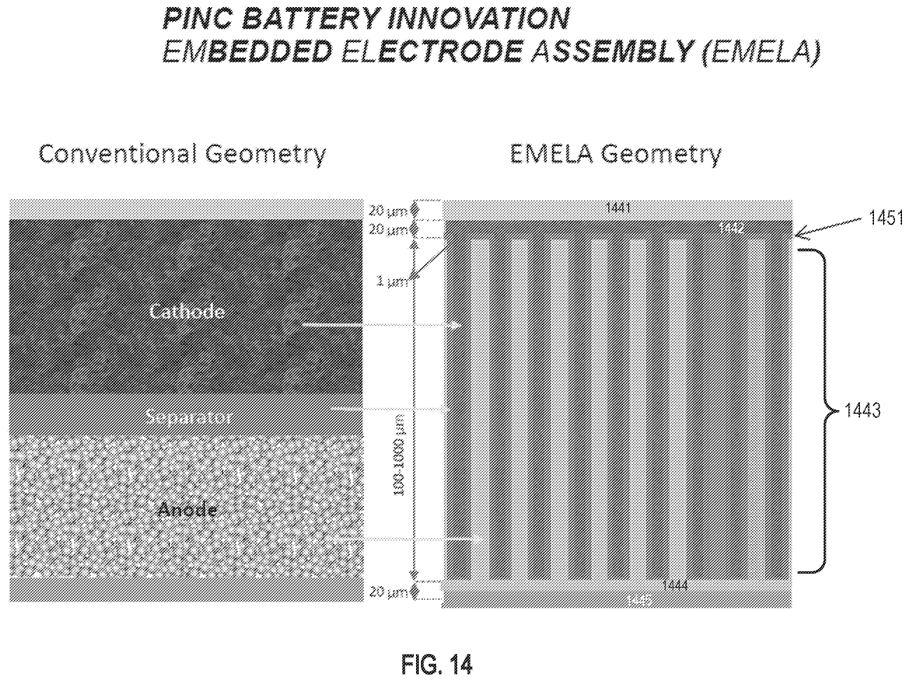

FIG. 2 illustrates components of an EMELA-based nano-device. In one embodiment, an anode 210 is porous silicon (FIG. 2, panel 1; FIG. 4, panel 1; and FIGS. 14, 15, and 17). FIG. 4 illustrates components of a nano-structured EMELA-based nano-device. The porosity may be based on a ‘random’ network of interconnected empty volumes as illustrated in FIGS. 2 and 3 or may be based on a micro-, or nano-, structured material 410 including a set of interconnected empty volumes 415 such as that illustrated in FIG. 4. In a particular embodiment, the oxide layer (or other separator layer such as a flexible polymer), e.g. separator layer 220, 320, 420, 1451, 1551, and/or 1751, generated (or deposited) on the internal surface of the pores/conductive substrate acts as a separator from the cathode material (FIG. 2, panel 2; FIG. 3, bottom panel;

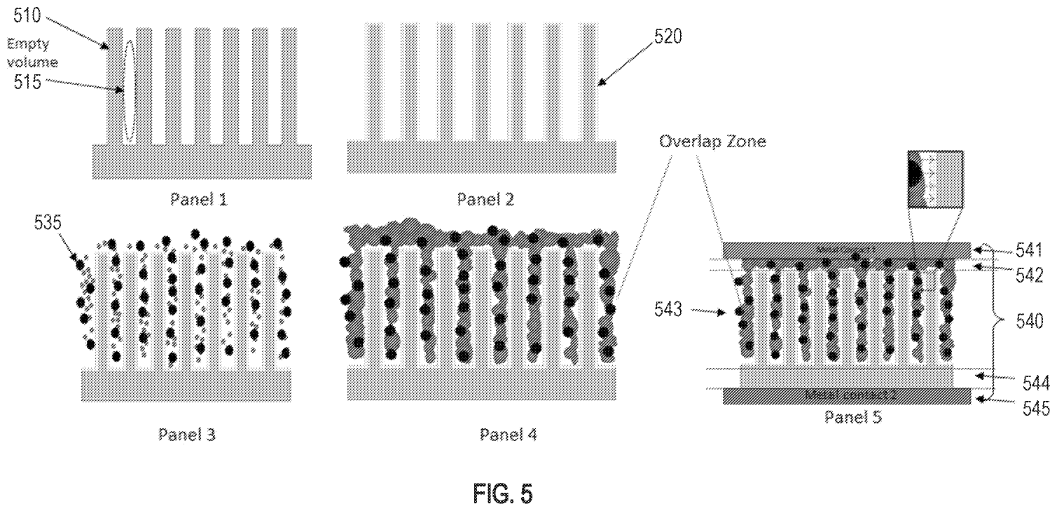

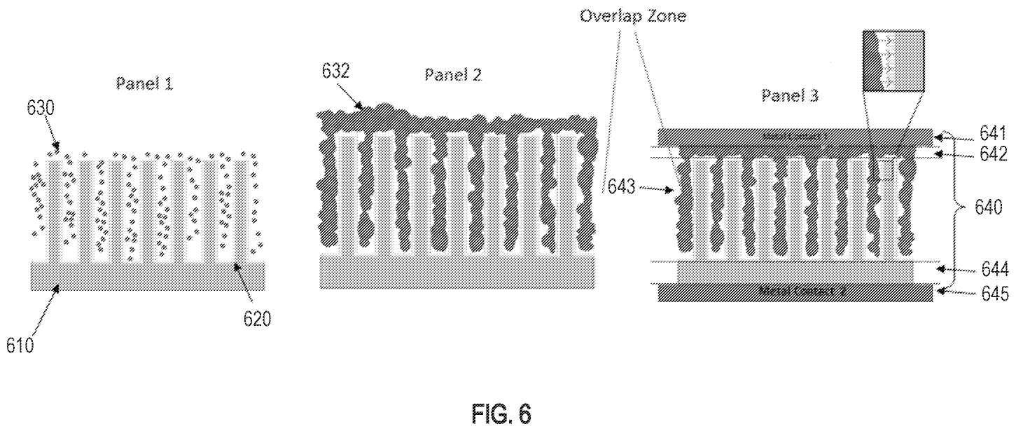

FIG. 4, panel 2; FIG. 5 panels 2 and 5; FIG. 6 last panel; and FIGS. 14, 15, and 17). In a particular embodiment, the cathode material is made up of particles and is dispersed within the pores such the particles fill the pores in high density (see FIG. 2, panel 3, FIG. 4, panel 3; FIG. 5, panels 3 and 4; FIG. 6, panels 1 and 2; and FIGS. 14, 15, and 17). The space (volume) between the particles and the continuous conductive substrate (or the separator layer) may be filled by electrolyte solution or solid state electrolyte 325. In particular embodiments, the porous conductive substrate is porous silicon, which is still electrically conductive (e.g., doped silicon). Suitable porous conductive substrates for use herein are well-known in the art, such as the MakroPore silicon membranes available from Millipore Sigma, set forth as catalog #s:
MP1501010, thickness 50 μm, pore diameter 1 μm, pore size 1.5 μm (interpore distance), size 10 mm×10 mm,
MP12001010, thickness 50 μm, pore diameter 2.5 μm, pore size 4.2 μm (interpore distance), size 10 mm×10 mm,
MP2501010, thickness 200 μm, pore diameter 1 μm, pore size 1.5 μm (interpore distance), size 10 mm×10 mm,
MP25200101, thickness 200 μm, pore diameter 2.5 μm, pore size 4.2 μm (interpore distance), size 10 mm×10 mm,
MP53501010, thickness 350 μm, pore diameter 5.5 μm, pore size 12 μm (interpore distance), size 10 mm×10 mm,
MP83501010, thickness 350 μm, pore diameter 8 μm, pore size 12 μm (interpore distance), size 10 mm×10 mm,
MP54751010, thickness 475 μm, pore diameter 5.5 μm, pore size 12 μm (interpore distance), size 10 mm×10 mm,
MP84751010, thickness 475 μm, pore diameter 8 μm, pore size 12 μm (interpore distance), size 10 mm×10 mm,
MP150205, thickness 50 μm, pore diameter 1 μm, pore size 1.5 μm (interpore distance), size 20 mm×20 mm,
MP12002010, thickness 50 μm, pore diameter 2.5 μm, pore size 4.2 μm (interpore distance), size 20 mm×20 mm,
MP2502010, thickness 200 μm, pore diameter 1 μm, pore size 1.5 μm (interpore distance), size 20 mm×20 mm,
MP25200201, thickness 200 μm, pore diameter 2.5 μm, pore size 4.2 μm (interpore distance), size 20 mm×20 mm,
MP53502010, thickness 350 μm, pore diameter 5.5 μm, pore size 12 μm (interpore distance), size 20 mm×20 mm,
MP83502010, thickness 350 μm, pore diameter 8 μm, pore size 12 μm (interpore distance), size 20 mm×20 mm,
MP54752010, thickness 475 μm, pore diameter 5.5 μm, pore size 12 μm (interpore distance), size 20 mm×20 mm, MP84752010, thickness 475 μm, pore diameter 8 μm, pore size 12 μm (interpore distance), size 20 mm×20 mm, and the like (Available from Sigma-Aldrich, Inc., St. Louis, MO 68178).

In a particular embodiment, MP2501010 (MP250105) is used having: thickness 200 m, pore diameter 1 μm, pore size 1.5 μm (interpore distance), size 10 mm×10 mm. In some aspects, similar porous silicon substrates may be fabricated and doped with one or more dopants to result in a particular electrical characteristic of the silicon substrate (e.g., a specified electrical conductivity) that is different from an electrical characteristic of the undoped porous silicon substrate.

In embodiments of the inventive EMELA, the density of the cathode particles is selected so that they fill the gaps/pores of the porous conductive substrate to form a continuous network of particles. In particular embodiments, substantially all of the plurality of particles (e.g., functioning as a cathode in this battery embodiment) are in direct contact with two or more particles of the plurality of particles forming a continuous particle network, which particles are dispersed within the pores of the porous conductive substrate (see FIG. 2, panel 3; FIG. 4, panel 3). In other embodiments, all of the plurality of particles are in direct contact with two or more particles of the plurality of particles forming a continuous particle network, which particles are dispersed within the pores of the porous conductive substrate. Cathode particles can be selected from all the available cathode materials, described herein, such as Lithium Cobalt Oxide (LCO), and the like.

### Example 1—Fabrication/Assembly of Nano-Battery

Porous silicon (210/310/410/510/610/710/1444/1544/1744) can be made using standard procedures well known in the art to function as an anode in this nano-battery embodiment (composite device 240/440/540). The porous silicon may include empty volumes (215/415/515). Mesoporous (100-500 nm pores) silicon serves as an ideal porous conductive substrate structure in particular embodiments. In some aspects, larger pores (e.g., 1-50 microns) may be used to provide improved performance with less stringent fabrication requirements. Next, an oxide layer 220/320/420/520/620 of FIGS. 2-6 or a polymer separator 1451/1551/1751 of FIGS. 14, 15, and 17 can be grown, or coated, on the exposed surface of the pores using multiple approaches known in the literature. Alternatively, or additionally, for some porous silicon substrates, the ambient atmosphere functions to oxidize the silicon, such that an oxide later is formed and functions as a separator layer (FIG. 2, panel 2; FIG. 3, panel 2).

As opposed to other conventional battery constructions, the anode material with the integrated separator layer (e.g., grown on, or coating the anode material and/or substrate) may be obtained and/or stored for later combination with the cathode material (e.g., the cathode particles or particle slurry) to produce the inventive composite device (e.g., battery or capacitor) without an additional separator material and/or separator component applied at the time of the combination. For example, in contrast to conventional battery construction involving the combination of a first anode material (or substrate), a second separator component, and a third cathode component into a ‘sandwich,’ the inventive battery construction may involve only a first anode component with the integrated separator layer and a second cathode component. In some aspects, both the conventional and inventive constructions may involve connecting the anode component and cathode components to terminals and/or contacts or placing the combined components in a housing for use in association with other devices.

In a particular battery embodiment, cathode particles (e.g., having an average diameter of 10-50 nm, 100-500 nm, or 1-5 microns depending on the porosity and/or pore size of a corresponding substrate) can be suspended in a solvent and can be mixed with carbon and the like, to form a particle-slurry, to improve the electronic conductivity. The particle slurry is dispersed throughout substantially all of the pores of the porous conductive substrate at a density of (conductive) particles within the slurry such that when the solvent is removed, there is a sufficient volume of particles to form a continuous conductive particle network. Subsequently, the particle-slurry complex, in some embodiments, is dried to remove the solvent forming a continuous conductive particle network (e.g., the CCPN). Accordingly, the porosity of the continuous porous conductive substrate may be effectively reduced. Then, the combined inventive EMELA porous conductive substrate/continuous-conductive-particle-network structure (e.g., in the volume 243, 443, 543, 643, 843, and 1443) can be filled with an electrolyte (e.g., electrolyte solution and/or solid state electrolyte 325), such as LiPF6 and the like, under an inert atmosphere and sealed. Next, an anodic current collector (e.g., 245, 445, 545, 645, 845, and 1445) can be connected to, or deposited on, the substrate (e.g., the PCS, the CCS, the PM, or the DPASS) from any part of the substrate (e.g., an anode-only zone 244, 444, 544, 644, 844, 1444, 1544, and 1744) where a short with the cathode material is prevented (see, e.g., FIG. 4, panel 4, metal contact 2; FIG. 5, panel 5, metal contact 2; FIG. 6, panel 3, metal contact 2; and FIG. 14 terminal 1445). Similarly, a cathodic current collector (e.g., 241, 441, 541, 641, 841, 1441, 1541, and 1741) can be connected to any part (e.g., a cathode-only zone 242, 442, 542, 642, 842, 1442, 1542, and 1742) where a short with the silicon (e.g., the anode material) is prevented (see, e.g., FIG. 4, panel 4, metal contact 2; FIG. 5, panel 5, metal contact 1; FIG. 6, panel 3, metal contact 1; and FIG. 14 terminal 1441). Then, the structure is sealed.

Another advantage of this inventive geometry is that it can take any shape and form that allows high efficiency packaging. The separator layer thickness (e.g., oxide layer, polymer layer, and the like) can be adjusted depending on the breakdown voltage of the medium. For a chemistry embodiment with a cell voltage around 3V, this thickness can be, for example 30-50 nm, or the like. The overlap zone, in this particular nano-battery embodiment, where anode and cathode is embedded can have a thickness around 100-300 μm. In other embodiments, the overlap zone thickness can range from 75-400 μm, 50-500 μm, 25-1000 μm, and the like. In other embodiments, the overlap zone thickness is no greater than: 1000, 900, 800, 700, 600, 500, 450, 400, 350, 300, 250, 200, 150, 100, 90, 80, 70, 60, 50, 40, 30, 20, 10, 5 μm, or the like.

### Example 2

In another embodiment of an inventive nano-device (e.g., 440/540/640), such as an inventive nano-battery, the anode is a silicon nanowire array substrate (FIG. 4, panel 1; and FIG. 5, panel 1; FIG. 6, panel 1). The oxide layer (e.g., oxide layer 420, 520, or 620) is generated on the outer surface of each silicon nanowire (e.g., silicon nanowire 410a) and functions as a separator layer (FIG. 4, panel 2; FIG. 5, panel 1). The cathode material corresponding to the continuous conductive particle network 430 (e.g., the CCPN; made up of conductive carbon particles in this embodiment), in some embodiments, fills the pores with a high density of particles (FIG. 4, panel 3).

The silicon nanowires, in some aspects, remain electrically conductive. The cathode particles fill the gaps within and/or between the array of nanowires with a sufficient amount of particles to form a continuous conductive particle network 430 (CCPN; FIG. 4, panels 3 and 4). Other cathode particles suitable for use herein can be selected from all the available cathode materials, such as those described herein, including Lithium Cobalt Oxide (LCO), carbon, and the like. In some aspects, after fabrication as a set of distinct nanowires, the array of nanowires may not remain as an array of distinct nanowires and may instead collapse into a tangled network similar to the porous continuous conductive network described above in relation to FIGS. 2 and 3.

### Example 3

In yet another embodiment, the anode is in the form of a silicon nanowire array (FIG. 4, panel 1; FIG. 5, panel 1; FIG. 6, panel 1). The oxide layer (e.g., oxide layer 420, 520, or 620) generated on the outer surface of each silicon nanowire acts as a separator (FIG. 4, panel 2; FIG. 5, panel 2). The cathode material corresponding to the continuous conductive particle network 430 (CCPN; made up of conductive carbon particles in this embodiment) fills the pores with a high density of particles (FIG. 4, panel 3). The silicon nanowires remain electrically conductive. The cathode particles fill the gaps within and/or between the array of nanowires with a sufficient amount of particles to form a continuous conductive particle network 430 (CCPN; FIG. 5, panels 3 and 4). In addition to the cathode particle material in the “slurry,” in this embodiment there are also metal particles 535 dispersed throughout the slurry to improve the conductivity (FIG. 4, panel 3, smaller red circles). In one embodiment, these metal particles can be gold particles. In further embodiments, these metal particles can also be used for further nucleation and growth using, for example, auric acid and the like to fuse the particles and improve the conductivity.

The silicon nanowires, in some aspects, remain electrically conductive. The cathode particles fill the gaps within and/or between the array of nanowires with a sufficient amount of particles to form a continuous conductive particle network (CCPN; FIG. 5, panels 4 and 5). Other cathode particles suitable for use herein can be selected from all the available cathode materials, such as those described herein, including Lithium Cobalt Oxide (LCO), carbon, and the like.

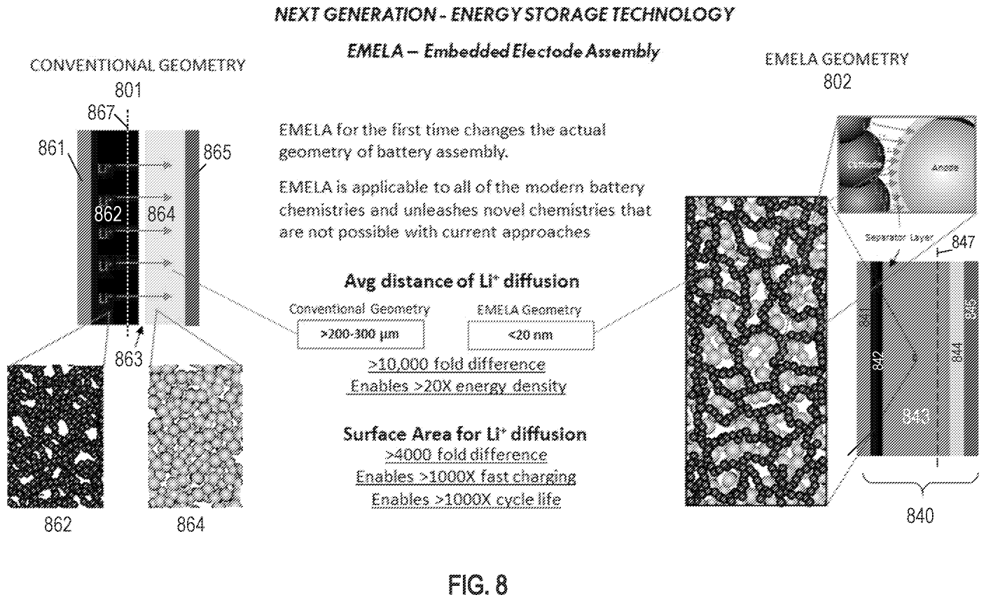

FIG. 8 includes a comparison of features of a first diagram 801 relating to a conventional battery geometry and a second diagram 802 relating to an EMELA battery geometry. Diagram 801 indicates that in a conventional geometry a cathode current collector 861 a bulk cathode material 862, a bulk anode material 864, an anode current collector 865, and a separator layer 863 that electrically separates the bulk cathode material 862 and the bulk anode material 864. Diagram 802 illustrates an EMELA structure comprising the cathode current collector 841, a cathode-only zone 842 that prevents a short between the cathode current collector and the anodic material in a volume 843 containing the EMELA structure. Similarly, diagram 802 illustrates that the EMELA structure further comprises an anode-only zone 844 and an anode current collector 845. FIG. 8 illustrates that an average distance for ionic diffusion in a conventional geometry may be greater than 200-300 μm (e.g., a size of the bulk cathode/anode material 862/864) while for an EMELA geometry an average distance for ionic diffusion may be less than 20 nm. In some embodiments, the difference in average distance for ionic diffusion may allow for a greater than 20-fold increase in energy density. Additionally, a surface area for ion diffusion may increase by a factor of greater than 1000-4000 which may enable a greater than 1000-fold increase in charging/discharging rate and a greater than 1000-fold increase in cycle life.

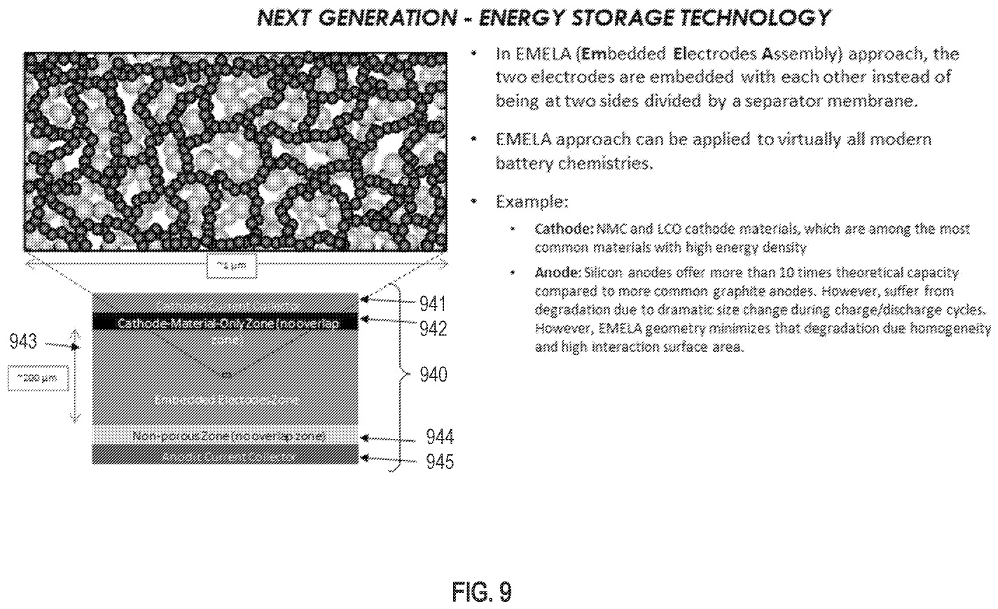

FIGS. 8 and 9 illustrate a composite device 840/940 utilizing the EMELA geometry including the cathode current collector 841/941, the cathode-only zone 842/942, the volume 843/943 containing the EMELA structure, the anode-only zone 844/944 and the anode current collector 845/945. FIG. 8 illustrates that the composite device 840 utilizing the EMELA geometry may utilize high-energy-density cathode materials. The composite device 840 utilizing the EMELA geometry may further utilize silicon anodes (or anodic material) that, in some embodiments, offer more than 10 times a theoretical capacity compared to more common graphite anodes. As opposed to using bulk silicon anodic material which may suffer from degradation due to dramatic size change during charge/discharge cycles, the composite device 840 utilizing the EMELA geometry, in some embodiments, minimizes the degradation due to homogeneity and a high interaction surface area.

As shown, the conventional battery structure depicted in diagram 801, the anode material 864 and the cathode material 862 are bulk materials (˜200-500 micrometers thick) physically separated by a separator layer 863 that may be tens to hundreds of micrometers thick while in the inventive (e.g., EMELA) battery structure depicted in diagram 802 the anode material and the cathode material are interleaved, embedded, and/or interspersed with (or within) each other in a region (or volume) 843. This fundamental difference between the conventional battery structure and the inventive battery structure provides the benefits described above in relation to power density, energy density, charging rates, etc. while still providing the same external interface (e.g., terminal (or contact) 841 and terminal (or contact) 845) for ease of adoption.

For example, the inventive battery structure illustrated in diagram 802 may achieve the maximum theoretical surface area for ion diffusion, thus reducing the ion current density dramatically. Additionally, a lithium ion diffusion length may be reduced to less than 1/1000 compared to the conventional battery structure that, when combined with the optimized surface area, allows for rapid charge/recharge rates. Furthermore, the dramatic increase in surface area leads to superior heat management and safety and the structure is expected to be compatible to most current and future chemistries such as solid state, lithium-metal, lithium-air, or other chemistries that may be discovered. Geometries with features on the order of 10 microns (e.g., instead of features on the order of 1 micron or less) as may be implemented in one or more embodiments similar to those illustrated in FIGS. 4-6, 14, 15, and 17, may still provide significant improvements over conventional battery structures. For example, surface area for ion diffusion may be increased, ion current densities may be reduced, and ion diffusion length may be reduced when compared to the conventional battery structure depicted in diagram 801 resulting in one or more orders of magnitude of an energy density, a power density, or charging rate. For example, an embodiment using a deep silicon array (e.g., a deep-pore-array silicon substrate, or DPASS) with a pore diameter of between 10 and 20 microns, an inter-pore distance (or pore spacing) of between 30 and 50 microns, and a depth of 300 to 1000 microns, may provide approximately 10 times the surface area for ion diffusion for a given metal contact (or anodic/cathodic collector) area. A deep-pore-array silicon substrate, in some aspects, may be fabricated in accordance with

In some embodiments, a composite device may include an active region (e.g., a region between terminals 241/245, 441/445, 541/545, 641/645, 841/845, 941/945, 1441/1445, and/or 1541/1545, or an active material). The material in the active region may be heterogeneous on a small scale while being homogeneous on a large scale. Small-scale heterogeneity is defined as having multiple types of components (e.g., two or more of an anodic material, a cathodic material, and/or a separator) in each, or a majority of, characteristic (cubic) volumes in the active region. The characteristic volume used to define the small-scale in some embodiments, may be cubic volumes having one of a side length of 1, 2, 3, 4, 5, 6, 7, 8, 9, 10, 20, 30, 40, 50, 60, 70. 80, 90, 100, 200, 300, 400, 500, 600, 700, 800, and/or 900 nm or one of a side length of 1, 2, 3, 4, 5, 6, 7, 8, 9, 10, 20, 30, 40, and/or 50 micrometers. Large-scale homogeneity refers herein to having each, or a majority of, the characteristic (cubic) volumes in the active region including the same types of components (e.g., two or more of an anodic material, a cathodic material, and/or a separator). In some embodiments, the majority of characteristic volumes may include a majority that is greater than 50%, 60%, 70%, 80%, 90%, 95%, 96%, 97%, 98%, 99%, 99.1%, 99.2%, 99.3%, 99.4%, 99.5%, 99.6%, 99.7%, 99.8%, and/or 99.9%. Accordingly, the composite device, in some embodiments, includes a large scale homogeneous active region with small-scale heterogeneity while a traditional device may include a large scale heterogeneous active region (e.g., including a majority of the associated characteristic volumes having at most one of the anodic, cathodic, or separator materials) with small-scale homogeneity (e.g., where each, or a majority of, the characteristic volumes includes a single type of component, either an anodic material, a cathodic material, or a separator).

For example, referring to FIG. 8, within the bulk material of the conventional battery, a majority of a set of characteristic volumes within the anode material 864 contains only anodic material, a majority of the set of characteristic volumes within the cathode material 862 contains only cathodic material, and a majority of a set of characteristic volumes within the separator layer 863 contains only separator material. Accordingly, the multiple volumes throughout the active region are not homogeneous (or are heterogeneous) on a large scale (e.g., do not include the same set of material types when considered as a single group) but each of a majority of the volumes is internally homogeneous (e.g., homogeneous on a small scale). However, throughout the active region of the inventive battery, a majority of the characteristic volumes may include all of anodic material, cathodic material, and separator material as described above, such that volumes throughout the active region are homogeneous compared to each other (e.g., on a large scale) while being internally heterogeneous (e.g., on a small scale).

### Example 4

In another embodiment, the inventive EMELA device is a capacitor. In this embodiment, one electrode is a silicon nanowire (e.g., nano-tower or other nanostructure) array (FIGS. 4-6, panel 1). The oxide layer (e.g., 420, 520, or 620) generated on the outer surface of each silicon nanowire acts as a dielectric layer (FIG. 6, panel 1). The other electrode is made up of metal particles (FIG. 6, panel 1, red circles). In one embodiment, these metal particles can be gold particles. These particles can also be used for further nucleation and growth using auric acid and the like to fuse the particles and improve the conductivity. The silicon nanowires remain electrically conductive. The metal particles (e.g., gold particles) fill the gaps within and/or between the array of nanowires with a sufficient amount of particles to form a continuous conductive particle network 632 (CCPN; FIG. 6, panels 2 and 3). Similarly, the structure described in relation to the deep silicon array (or DPASS) of FIGS. 14, 15, and 17 may be modified (e.g., may use a different cathodic material) to produce a capacitor.

Accordingly, provided herein is an EMELA, comprising:
a porous conductive substrate capable of conducting or storing a charge, wherein said substrate comprises a plurality of pores,
a continuous particle network comprising a plurality of conductive particles, wherein the conductive particles are dispersed within the pores of the porous conductive substrate, wherein substantially all of the plurality of particles are in direct contact with two or more particles of the plurality of particles forming a continuous particle network.

In a particular embodiment, the EMELA further comprises a first and second terminal, wherein the first terminal is attached to the porous conductive substrate and the second terminal is attached to the continuous particle network. In a further embodiment, the terminals are part of a composite-device.

In some embodiments, the composite-nano-device further comprises a separator/stabilization-layer (e.g., a separator layer that does not conduct electrons, or allow electrons to pass, between the CCPN and the PCS, the CCS, the PM, or the DPASS, but does conduct ions, or allow ions to pass, between the CCPN to the PCS, the CCS, the PM, or the DPASS) positioned around the plurality of particles and/or the conductive porous substrate. In some embodiments, the separator/stabilization-layer comprises a material that is porous and configured for ion diffusion while being electrically non-conductive. One or more of the diameter of each particle and the thickness for the separator/stabilization layer, in some aspects, may be selected from the group consisting of: 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 60, 70, 80, 90 and 100 nm. In some aspects, one or more of the diameter of each particle and the thickness for the separator/stabilization layer, in some aspects, may be selected from the group consisting of: 200 nm, 300 nm, 400, nm, 500 nm, 600 nm, 700 nm, 800 nm, 900 nm, 1 micron, 2 microns, 3 microns, 4 microns, 5 microns, 6 microns, 7 microns, 8 microns, 9 microns, and 10 microns.

In particular embodiments, the diameter of each particle of the first and/or second plurality of particles is selected from the group consisting of: from about 1 nm to about 900 nanometers; from about 2 nm to about 500 nm; from about 3 nm to about 300 nm; from about 4 nm to about 200 nm; from about 5 nm to about 150 nm; from about 10 nm to about 150 nm; from about 15 nm to about 150 nm; from about 15 nm to about 100 nm; 20 nm to about 75 nm; from about 25 nm to about 50 nm.

Also provided herein is a composite-nanobattery comprising the composite-nano-device set forth herein, wherein the first terminal is an electrode comprising a plurality of cathode-particles comprising a material selected from the group consisting of: Bismuth Trioxide, Cobalt Oxide Particles, Iron Disulfide, Lithium Aluminum Alloy, Lithium Carbonate, Lithium Cobalt Oxide, Lithium Cobalt Phosphate, Lithium Hydroxide, Lithium Hydroxide, Lithium Iron Phosphate (LFP), Lithium Iron (III) Oxide, Lithium Manganese Dioxide, Lithium Manganese Nickel Oxide (LMNO), Lithium Manganese Oxide (LMO), Lithium Molybdate, Lithium Nickel Cobalt Aluminum Oxide, Lithium Nickel Cobalt Oxide, Lithium Nickel Dioxide, Lithium Nickel Manganese Cobalt Oxide (NMC), Lithium Silicon Alloy, Lithium Tin Alloy, Lithium Titanate, Lithium Titanate Spinel, Manganese (IV) Oxide, Nickel Hydroxide, Silver Chromate, Silver Oxide, and/or Vanadium Pentoxide.

In particular embodiments, the second terminal is an electrode comprising a plurality of anode-particles comprising a material selected from the group consisting of. Carbon, Copper Carbon, Copper Chloride, Copper Sulfide, Copper (II) Oxide, Graphene, Graphene Oxide Monolayer, Graphite, Manganese Selenide, Potassium Graphite, Pyrolytic Graphite, Silicon, Tin Oxide, lithium metal and Zinc.

In some embodiments, the EMELA may comprise:
a continuous conductive substrate (PCS, the CCS, or the PM) comprising a network of interconnected empty volumes, wherein said (PCS, the CCS, or the PM) is capable of conducting or storing a charge; and
a continuous conductive particle network (CCPN) comprising a plurality of conductive particles, wherein the conductive particles are embedded within the network of interconnected empty volumes of the PCS, the CCS, or the PM.

In some embodiments, substantially all of the plurality of particles are in direct contact with two or more particles of the plurality of particles forming the CCPN. The EMELA, in some embodiments, may further comprise an anodic component electrically separate from the CCPN and electrically connected to the PCS, the CCS, or the PM. In some embodiments, the anodic component comprises an anodic current collector. The EMELA, in some embodiments, further comprises a cathodic component electrically separate from the PCS, the CCS, the PM, or the DPASS and electrically connected to the CCPN. The cathodic component, in some embodiments, comprises a cathodic current collector.

The EMELA, in some embodiments, further comprises an electrolyte material comprising a medium for a transfer of ions between the PCS, the CCS, the PM, or the DPASS and the CCPN. The electrolyte material may fill interstices between the PCS, the CCS, the PM, or the DPASS and the CCPN and promote the transfer of ions between the PCS, the CCS, the PM, or the DPASS and the CCPN. In some aspects, the electrolyte material comprises a solvent and a solute. In other embodiments, the electrolyte material comprises a solid state electrolyte material. The solid state electrolyte material, in some embodiments, is a conductor for the ions and an insulator for electrons.

In some embodiments of the EMELA, the PCS, the CCS, the PM, or the DPASS comprises a silicon-based substrate and the CCPN comprises a lithium-based particle. In certain embodiments of the invention, the PCS, the CCS, the PM, or the DPASS comprises a material selected from the group consisting of one or more of: Carbon, Copper Carbon, Copper Chloride, Copper Sulfide, Copper(II) Oxide, Graphene, Graphene Oxide Monolayer, Graphite, Manganese Selenide, Potassium Graphite, Pyrolytic Graphite, Silicon (e.g., a silicon deep array (or deep hole array) as discussed in relation to FIGS. 14-18 below, a porous silicon structure as discussed in relation to FIGS. 2 and 3, or silicon nanowires as discussed in relation to FIG. 4, panel 1, or other similar structures), Tin Oxide, Lithium metal, and/or Zinc.

The PCS, the CCS, or the PM, in some embodiments, comprises a carbon-based substrate and the CCPN comprises a lithium-based particle. In certain embodiments of the invention, the CCPN comprises a material selected from the group consisting of one or more of: Bismuth Trioxide, Cobalt Oxide Particles, Iron Disulfide, Lithium Aluminum Alloy, Lithium Carbonate, Lithium Cobalt Oxide, Lithium Cobalt Phosphate, Lithium Hydroxide, Lithium Hydroxide, Lithium Iron Phosphate (LFP), Lithium Iron (III) Oxide, Lithium Manganese Dioxide, Lithium Manganese Nickel Oxide (LMNO), Lithium Manganese Oxide (LMO), Lithium Molybdate, Lithium Nickel Cobalt Aluminum Oxide, Lithium Nickel Cobalt Oxide, Lithium Nickel Dioxide, Lithium Nickel Manganese Cobalt Oxide (NMC), Lithium Silicon Alloy, Lithium Tin Alloy, Lithium Titanate, Lithium Titanate Spinel, Manganese (IV) Oxide, Nickel Hydroxide, Silver Chromate, Silver Oxide, and/or Vanadium Pentoxide.

In some embodiments, one or more of the PCS, the CCS, the PM, or the DPASS and/or the CCPN further include particles or other components of at least a second type. The second type of particle or component may be introduced to improve characteristics of the PCS, the CCS, the PM, or the DPASS and/or CCPN. For example, the second type of particle or component (e.g., element) may be used to improve a conductivity, a stability, a structural integrity, or other characteristic of the PCS, the CCS, the PM, or the DPASS and/or CCPN.

In some embodiments, a non-conductive separator layer is interposed between the PCS, the CCS, the PM, or the DPASS and the CCPN. The non-conductive separator layer, in some embodiments, is an oxide layer formed on the surface of the PCS, the CCS, or the PM. In some embodiments, the separator layer is deposited on the surface of the PCS, the CCS, or the PM. The separator layer, in some embodiments, is a polymer layer.

In some aspects, a characteristic size of the empty volumes that comprise the interconnected empty volumes is less than one of 100, 90, 80, 70, 60, 50, 40, 30, 20, 10, 9, 8, 7, 6, 5, 4, 3, 2, or 1 micrometers. In some aspects, a characteristic size of the empty volumes that comprise the interconnected empty volumes is less than one of 900, 800, 700, 600, 500, 400, 300, 200, 100, 90, 80, 70, 60, 50, 40, 30, 20, 10, 9, 8, 7, 6, 5, 4, 3, 2, or 1 nanometers. The characteristic size may be associated with a ratio between a volume associated with the interconnected empty volumes and a surface area associated with the interconnected empty volumes.

In some embodiments, a characteristic size of the conductive particles, e.g., a radius (for example, a largest radius, an average radius, etc.) or a ratio of between a volume associated with the conductive particles and a surface area of the conductive particles, is less than the characteristic size of the interconnected empty volumes (or the characteristic size of the empty volumes that comprise the interconnected empty volumes). The characteristic size of the conductive particles, in some embodiments, is less than one of 90%, 80%, 70%, 60%, 50%, 40%, 30%, 20%, and/or 10% of the characteristic size of the empty volumes. In some embodiments, a standard deviation of the size of the conductive particles is one or more of 1%, 3%, 5%, 10%, 15%, 20%, 25%, 30%, 35%, 40%, 45%, and/or 50% of the characteristic size of the conductive particles.

In some embodiments, an average ionic diffusion distance for ions diffusing from the CCPN to the PCS, the CCS, the PM, or the DPASS (e.g., during a charging operation), or from the PCS, the CCS, the PM, or the DPASS to the CCPN (e.g., during a discharging operation), is less than one of 100, 50, 10, and/or 1 micrometers. In some embodiments, an average distance from any point within the CCPN to a closest point within the PCS, the CCS, the PM, or the DPASS, or from a point in the continuous particle network to a closest point in the PCS, the CCS, the PM, or the DPASS, is less than one of 100, 50, 10, and/or 1 micrometers. In some embodiments, an average ionic diffusion distance (e.g., during a charging operation) for ions diffusing from the CCPN to the PCS, the CCS, the PM, or the DPASS (or vice versa for a discharging operation), or from the porous conductive substrate to the continuous particle network, is less than one of 900, 800, 700, 600, 500, 400, 300, 200, 100, 90, 80, 70, 60, 50, 40, 30, 20, 10, 9, 8, 7, 6, 5, 4, 3, 2, or 1 nanometers. In some embodiments, an average distance from any point within the CCPN to a closest point within the PCS, the CCS, the PM, or the DPASS, or from a point in the CCPN to a closest point in the PCS, the CCS, the PM, or the DPASS, is less than one of 900, 800, 700, 600, 500, 400, 300, 200, 100, 90, 80, 70, 60, 50, 40, 30, 20, 10, 9, 8, 7, 6, 5, 4, 3, 2, or 1 nanometers. In some embodiments, a charging operation comprises one of a multidirectional flow of ions from the CCPN to the PCS, the CCS, the PM, or the DPASS or an omnidirectional flow of ions from the CCPN to the PCS, the CCS, the PM, or the DPASS.

As used, the phrase “omnidirectional flow” refers to a flow of ions throughout the EMELA in substantially all directions during a charging or discharging operation. The omnidirectional flow of ions may be used to describe a plurality of ion flows (or diffusion of a plurality of individual ions) within a specified volume of the EMELA (e.g., a small-scale-heterogeneous volume within, for example, the volume 243, 443, 543, 643, 843, and/or 1443) that include different ion flows (or diffusions) in each of a plurality of opposite directions, e.g., along each of the three principal directions (or axes) in a Cartesian coordinate system. Omnidirectional flow, as used, may also be used to describe a situation in which, during a charging or discharging operation, the ion flux across a plane (or a majority of the planes) through the EMELA, e.g., parallel to the anodic and/or cathodic current collector similar to cross section 847, within the small-scale-heterogeneous volume or region is effectively zero compared to an ion flow during a charging or discharging operation across a similar plane (e.g., a cross section 867 that is parallel to a planar separator layer 863) of a conventional battery geometry such as shown in FIG. 8. For example, the relative ion flux across the plane (e.g., the cross section 847) through the EMELA may be one of 10⁻², 10⁻³, 10⁻⁴, 10⁻⁵, 10⁻⁶, 10⁻⁷, 10⁻⁸, or 10⁻⁹ of the ion flux across the corresponding plane (e.g., the cross section 867) of the conventional battery geometry.

As used, the phrase “multidirectional flow” refers to a flow of ions throughout the EMELA in a plurality of directions during a charging or discharging operation. The multidirectional flow of ions may be used to describe a plurality of ion flows (or diffusion of a plurality of individual ions) within a specified volume of the EMELA (e.g., a small-scale-heterogeneous volume within, for example, the volume 243, 443, 543, 643, 843, and/or 1443) that include different ion flows in at least one set of (but not all) opposite directions, e.g., along at least one of the three principal directions (or axes) in a Cartesian coordinate system (e.g., a coordinate system with one axis aligned with a central axis of a deep pore of a DPASS). Multidirectional flow, as used, may also be used to describe a situation in which, during a charging or discharging operation, the ion flux across a plane (or a majority of the planes) through the EMELA, e.g., parallel to the anodic and/or cathodic current collector similar to cross section 847, within the small-scale-heterogeneous volume or region is effectively zero compared to an ion flow during a charging or discharging operation across a similar plane (e.g., a cross section 867 that is parallel to a planar separator layer 863) of a conventional battery geometry such as shown in FIG. 8. For example, the relative ion flux across the plane (e.g., the cross section 847) through the EMELA may be one of 10⁻², 10⁻³, 10⁻⁴, 10⁻⁵, 10⁻⁶, 10⁻⁷, 10⁻⁸, or 10⁻⁹ of the ion flux across the corresponding plane (e.g., the cross section 867) of the conventional battery geometry.

The EMELA, in some embodiments, further comprises a first and second terminal, wherein the first terminal is attached to the PCS, the CCS, the PM, or the DPASS and the second terminal is attached to the CCPN. In some embodiments, the terminals are part of a composite-device. The composite-device is a composite-nanobattery or a composite nano-capacitor.

In some embodiments, the composite-device, e.g., the EMELA, is capable of being charged from 10 percent to 90 percent in less than one of one hour, 45 minutes, 30 minutes, 10 minutes, 1 minute, 45 seconds, 30 seconds, 10 seconds, 5 seconds, 1 second, 0.1 second, 1×10⁻² seconds, 1×10⁻³ seconds, 1×10⁻⁴ seconds, 1×10⁻⁵ seconds, and/or 1×10⁻⁶ seconds. In some embodiments, the composite-device is capable of being charged and discharged for at least one of 1×10³, 5×10³, 1×10⁴, 5×10⁴, 1×10⁵, 5×10⁵, 1×10⁶, 5×10⁶, 1×10⁷, 5×10⁷, 1×10⁸, 5×10⁸, and/or 1×10⁹ cycles before breakdown, wherein a breakdown comprises an uncontrolled discharge of energy. In some embodiments, the composite-device is capable of being charged and discharged for at least one of 1×10³, 5×10³, 1×10⁴, 5×10⁴, 1×10⁵, 5×10⁵, 1×10⁶, 5×10⁶, 1×10⁷, 5×10⁷, 1×10⁸, 5×10⁸, and/or 1×10⁹ cycles while achieving at least 80 percent of an initial charge.

In some embodiments, a ratio between a surface area of an interface between the PCS, the CCS, the PM, or the DPASS and the and the CCPN and a volume of the EMELA is greater than 200 cm⁻¹, 500 cm⁻¹, 1000 cm⁻¹, 5000 cm⁻¹, 1×10⁴ cm⁻¹, 5×10⁴ cm⁻¹, 1×10⁵ cm⁻¹, 1×10⁶ cm⁻¹, 1×10⁷ cm⁻¹, 1×10⁸ cm⁻¹. The empty volumes (or the volume of the pores) of the PCS, the CCS, the PM, or the DPASS, in some embodiments, comprise one or more of 1%, 5%, 10%, 15%, 20%, 25%, 30%, 35%, 40%, 45%, and/or 50% unfilled volume after the conductive particles are embedded within the network of interconnected empty volumes (or pores) of the PCS, the CCS, the PM, or the DPASS. In some embodiments, the empty volumes, the pores, or the unfilled volume accommodates expansion (or swelling) of the PCS, the CCS, the PM, or the DPASS during a charging operation.

In some embodiments, a gravimetric energy density of the EMELA is greater than one of 300, 1000, 2000, 5000, 10×10³, and/or 20×10³ Wh/Kg. The power density of the EMELA, in some aspects, is greater than at least one of 300, 500, 1000, 2000, 3000, 4000, 5000, 6000, 7000, 8000, 9000, 10×10³, and/or 20×10³ W/Kg. In some embodiments, a volumetric energy density of the EMELA is greater than at least one of 5, 10, 15, 20, 30, 40, and/or 50 MJ/L.

Also provided herein are methods for manufacturing a composite-nanobattery set forth herein; and methods for manufacturing a nanocapacitors set forth herein.

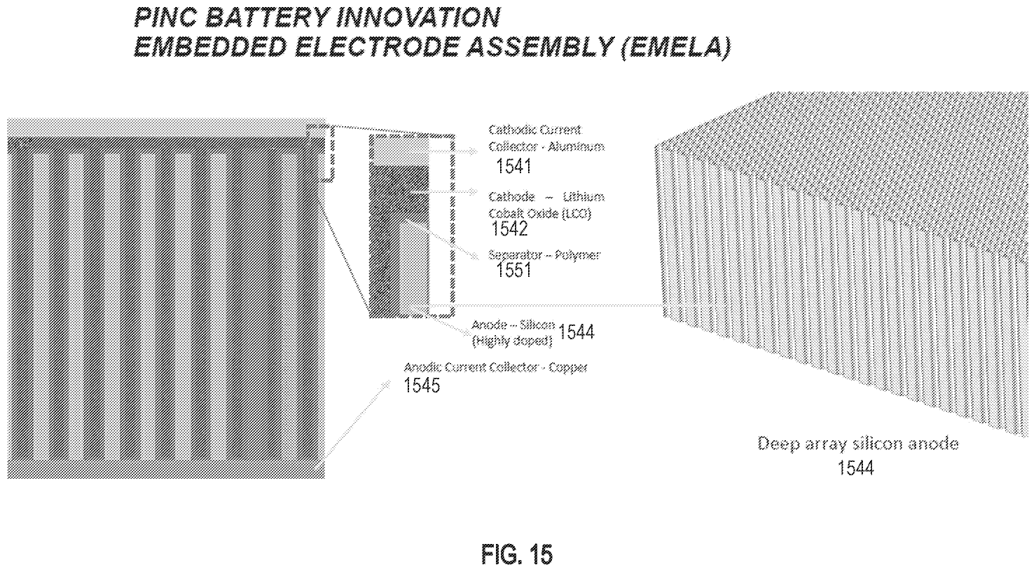

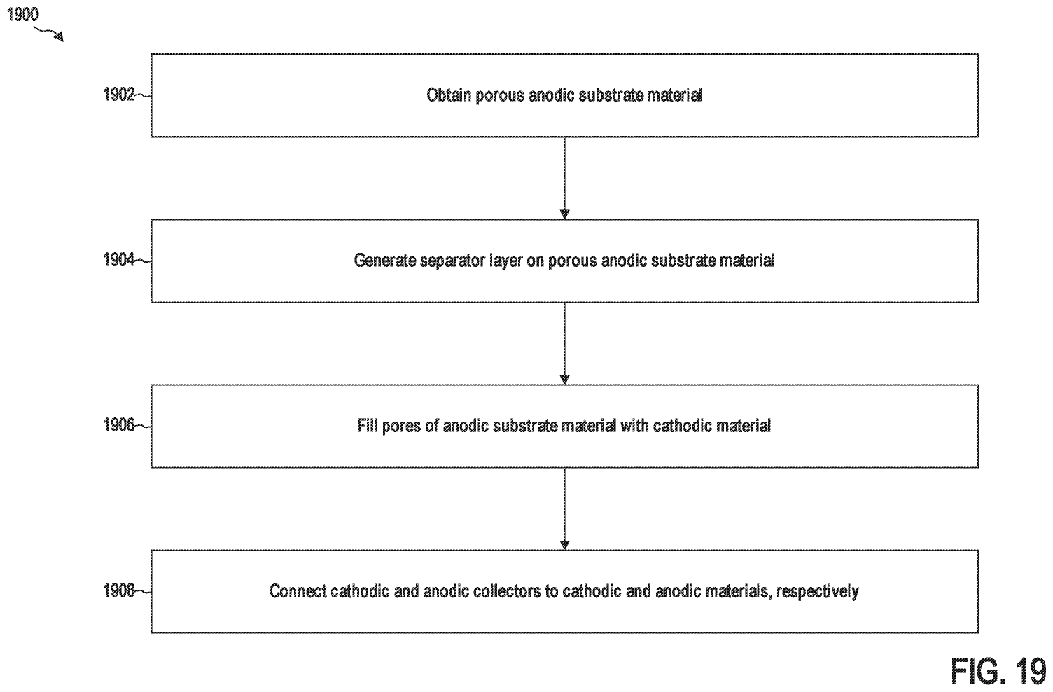

FIG. 19 is a method of manufacturing a composite nano-device in accordance with some aspects of the disclosure. The method may include obtaining, at 1902, a porous anodic substrate material (e.g., the PCS, the CCS, the PM, or the DPASS). The porous anodic substrate material may be of any structure and material discussed above (e.g., doped silicon). For example, the porous anodic substrate may be a deep silicon array (e.g., a silicon-based substrate with a set of pores, or holes (where references to pores above may be interpreted as referring to either pores or holes), extending from a first face of the substrate through most or all of the substrate materials towards an opposite face of the substrate as illustrated in FIGS. 15, 17, and 18). In some aspects, the porous anodic substrate material may include a first side, or face, on which a layer of copper or other conductive metal used for the anode is deposited to be used to make electrical connections with other devices. A deep silicon array, in some aspects, may be fabricated by methods (e.g., deep reactive ion etching (DRIE)) known in the art as described in at least U.S. Pat. No. 7,396,479 issued Jul. 8, 2008.

The method may then proceed to generate, at 1904, a separator layer (an oxidation layer or polymer layer) on the porous anodic structure material obtained at 1902. In some aspects, a flexible polymer-based separator layer may be generated (e.g., grown, deposited, or otherwise bonded) on the porous anodic structure material using known methods with optimized thicknesses and/or chemistry. The generated separator layer may be one of 100 nanometers to 10 microns thick and may have a thickness of 1 micron in some aspects. In some aspects, the porous anodic substrate material obtained at 1902 may already have an integrated separator layer (e.g., an oxidized layer of the substrate or an applied separator layer).

The method further includes filling, at 1906, the pores of the porous anodic substrate material with cathodic material. In some aspects, the cathodic material may be any of the cathodic material discussed above (e.g., a continuous (micro- or nano-)particle network or (micro- or nano-)particle slurry that is a precursor to a continuous (micro- or nano-)particle network). As noted above, if the porous anodic substrate material obtained at 1902 is integrated with a separator layer, the filling, at 1906, may take place with no additional steps related to the separator layer (e.g., without an additional/distinct separator component being interposed between the cathodic material and the substrate).

The method may further include connecting, at 1908, cathodic and anodic collectors to the cathodic material and the porous anodic substrate material, respectively. Connecting the anodic collector to the porous anodic substrate material at 1908, in some aspects, may include depositing (e.g., via an evaporative process) a metal onto a surface of the porous anodic substrate material to improve (or form) the electrical connection.

### Capacitors

In the case of capacitors, the previous improvements have focused on reducing the distance between the two electrodes and again increasing the charge capacity. However, increasing energy density by improving the porosity, thus effective thickness of the electrode does not always directly translate to energy capacity. In traditional capacitors, the electrodes can hold a great deal of charge, however the distance cannot be reduced much by existing materials. New generation capacitors try to increase the charge density of electrodes. Then, to reduce the distance they use a double layer. Use of double layers causes a very thin voltage barrier that generates an electric field. Since the electric field is inversely proportional with the distance, that very little layer helps to improve capacitance. However, the problem is that you cannot increase the total voltage, and thus the charge it carries because the double layer breaks when using high voltages.

Accordingly, provided herein is a nano-capacitor comprising: a first porous conductive substrate configured as a first electrode; and a second continuous particle network comprising a plurality of conductive particles configured as a second electrode that is differently charged from the first electrode. For example, the first porous conductive substrate and the second continuous particle network comprising a plurality of conductive particles may be electrically connected to a respective terminal. In particular embodiments of the nano-capacitor, the first and/or second electrode is a metal selected from the group consisting of one or more of gold, silver, iron and platinum, and the like, such that the first and second electrodes can comprise the same or different metals. Thus, those of skill in the art will understand that the first electrode “and” second electrode; as well as the first electrode “or” the second electrode is a metal selected from the group consisting of gold, silver, iron and platinum, and the like.

In particular embodiments of the nano-capacitor, a dielectric material forming the separator layer can be used, wherein the dielectric material is an oxide selected from the group consisting of one or more of MgO, TiO₂, SiO₂, or any mixture thereof, and the like.

US 2020/0274190A1 is incorporated herein by reference in its entirety for all purposes.

### EXAMPLES

In another embodiment, the inventive EMELA device (e.g., 640) is a capacitor. In this embodiment, one electrode (terminal) is a silicon nanowire array 610 (FIG. 6, panel 1). The oxide layer 620 generated on the outer surface of each silicon nanowire (or a separator layer deposited on the outer surface of each silicon nanowire) acts as a dielectric layer (FIG. 6, panel 1). The other electrode is made up of metal particles 630 (FIG. 6, panel 1, red circles). In one embodiment, these metal particles 630 can be gold particles. These particles can also be used for further nucleation and growth using auric acid and the like to fuse the particles and improve the conductivity. The silicon nanowires remain electrically conductive. The metal particles (e.g., gold particles) fill the gaps within and/or between the array of nanowires with a sufficient amount of particles to form a continuous conductive particle network 632 (CCPN; FIG. 6, panels 2 and 3).

Next, a first metal contact 641 can be connected to the metal particles 630 and/or the continuous conductive particle network from any part (e.g., zone 642) where a short with the anode material is prevented. Similarly, a second metal contact 645 can be connected to any part (e.g., zone 644) of the silicon nanowire array 610 where a short with the silicon nanowire array 610 material is prevented (see, e.g., FIG. 6, panel 3, metal contact 2). Then, the structure is sealed.

### Advantages

Certain embodiments above utilize the porous conductive substrate and the continuous particle network comprising a plurality of conductive particles in a nano-device.

FIGS. 8-12 illustrate a set of advantages of the EMELA geometry. Advantageously, this inventive nano-capacitors benefit from one or more of the following:
The shortening of the distance between the electrodes increases capacitance and forms electric fields with neighboring electrodes in three dimensions.
Can utilize various different materials as the dielectric.
Voltage dependent on the distance.
Capacitance dependent on the voltage.
As the distance decreases, capacitance decreases, but the total voltage increases as the breakdown voltage increases, such that various configurations can be accommodated.
The inventive capacitor can store energy as well as supercapacitors, if not better, and has additional benefits over supercapacitors. For example, even the best supercapacitors lose about 20% of their energy per day, and therefore, are not suitable for long-term storage. Accordingly, supercapacitors are only used for very short-term storage. On the other hand, the disclosed capacitor can store energy for a very long time, while matching or exceeding the specific energy of supercapacitors. The disclosed capacitor is a very stable energy storage device that can hold its charge for a very long time. The number of cycles that the disclose capacitor can go through is >>1000× compared to rechargeable batteries.

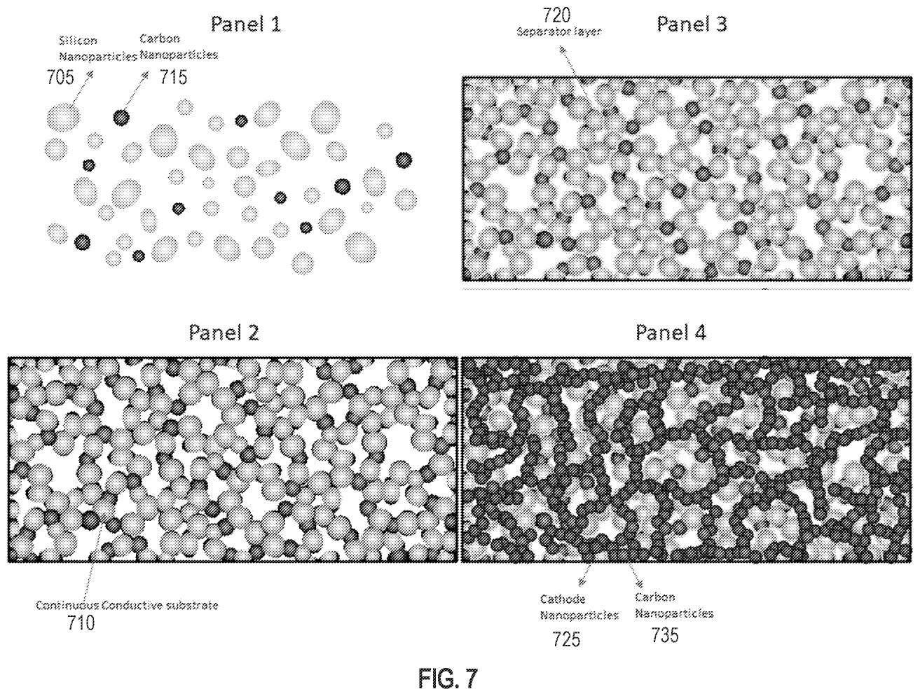

Thus, the inventive nano-battery advantageously provides benefits from one or more of the following:
Significantly shortens the flow distance for ions.
Dramatically increases the surface area.
Dramatically increases the charging rate.
Dramatically reduces dendrite formation. One of the most important factors that leads to dendrite formation is the ion current density. The novel geometry of the disclosed battery increases the surface area and reduces the ion current density dramatically throughout the entire active medium. The ion current distribution becomes even compared to conventional geometry, in which there are hot spots with high ion current density that lead to dendritic growth.
Makes heat management more efficient as the ratio of surface area to volume increases significantly.
There are numerous paths for current and ions to flow. Thus, the disclosed battery is less prone to failures.
The active region is much more homogeneous than heterogeneous.
Since the distance between anode and cathode pairs is much shorter, ionic conductivity is not a big issue.
One of the limitations of conventional geometry is the limited ion conductivity across the separator/active medium. On average, an ion diffuses for a distance of around 200 microns in conventional geometries. On the other hand, in the geometry of the disclosed battery, ions flow in a range of several tens of nanometers (e.g., 10 nm, 20 nm, 30 nm, 40 nm). This short diffusion distance leaves a lot of margin to tolerate low ionic conductivity. With the disclosed geometry (as shown in FIGS. 2-10), materials can be used that have as low as 1/10,000 ionic conductivity, if not lower.
Lithium air batteries can provide energy densities more than 10 times that of lithium-ion batteries. However, they are limited due to electroplating/dendritic growth and high rate of oxidation. The materials that would allow operation to some degree present extremely low ionic conductivities. On the other hand, due to the short distance of ion diffusion achieved by the disclosed geometry, extremely low ionic conductivity is not an issue. The disclosed geometry could make lithium-ion chemistry feasible/a reality for the first time. Thus, lithium ion batteries can provide more than 10-fold higher specific energy while being able to charge in a matter of seconds/sub-seconds.
Lithium metal battery chemistries increase energy density, but are also limited by electroplating/dendritic growth of lithium. In the disclosed battery, the reduction of ionic conductivity through the active medium and homogeneous ion current distribution enables such chemistries.

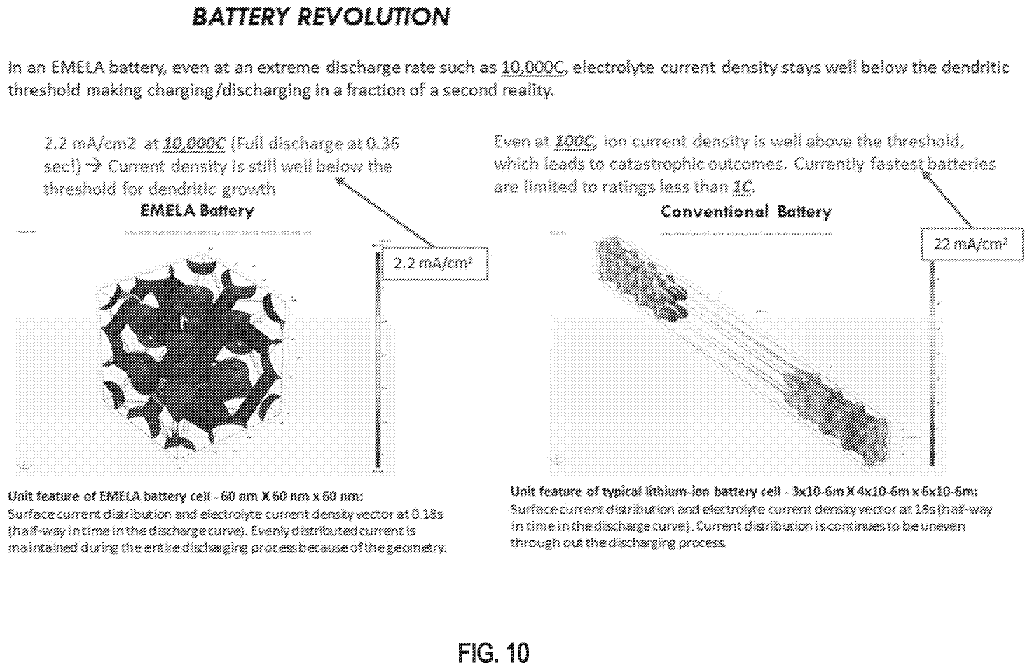

For example, FIG. 10 illustrates that even at an (extremely) high charge/discharge rate of 10,000 C for an EMELA battery a current density (2.2 mA/cm²) is well below a current density value (e.g., a threshold value of ˜6 mA/cm²) associated with dendritic growth, while for a charging/discharging rate of only 100 C for a conventional battery a current density (22 mA/cm²) is well above the current density value associated with dendritic growth. Accordingly, while the conventional battery geometry is usually limited to a charging/discharging rate of 1 C or less, while an EMELA battery may use a charging/discharging rate of 10,000 C while maintain a same current density.

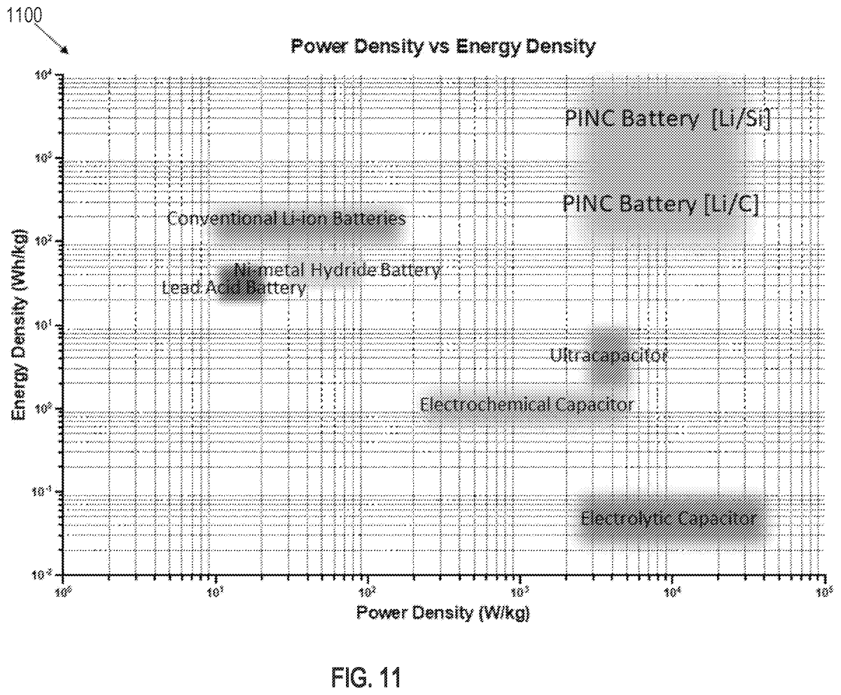

FIG. 11 illustrates a range of energy densities (Wh/Kg) and power densities (W/Kg) for different configurations (e.g., materials and geometries) of conventional batteries or capacitors. FIG. 11 illustrates that the EMELA batteries in some embodiments may provide a factor of 100-1000 improvement over conventional batteries or conventional capacitors in one or more of an energy density or a power density.

In embodiments provided herein, the diameter of each of the particles may be in the range selected from the group consisting of: from about 0.1-1000 nm; 0.2-1000 nm; 0.3-1000 nm; 0.4-1000 nm; 0.5-1000; 0.6-1000 nm; 0.7-1000 nm; 0.8-1000 nm; 0.9-1000 nm; 1 nm to about 900 nanometers; from about 2 nm to about 500 nm; from about 3 nm to about 300 nm; from about 4 nm to about 200 nm; from about 5 to about 150 nm; from about 10 to about 150; from about 15 nm to about 150 nm; from about 15 nm to about 100 nm; from about 20 nm to about 75 nm; from about 10 to about 60 nm; from about 0.5 to about 60 nm; and from about 25 nm to about 50 nm. In other embodiments, the diameter of each of the particles is selected from the group consisting of no greater than: 900 nm; 800 nm, 700 nm, 600 nm, 500 nm, 450 nm, 400 nm, 350 nm, 300 nm, 275 nm, 250 nm, 225 nm, 200 nm, 175 nm, 150 nm, 125 nm, 100 nm, 90 nm, 80 nm, 70 nm, 60 nm, 50 nm, 45 nm, 40 nm, 35 nm, 30 nm 25 nm, 20 nm, 19 nm, 18 nm, 17 nm, 16 nm, 15 nm, 14 nm, 13 nm, 12 nm, 11 nm, 10 nm, 9 nm, 8 nm, 7 nm, 6 nm, 5 nm, 4 nm, 3 nm, 2 nm and no greater than 1 nm.

In a particular embodiment, the diameter of the particles is 20 to 60 nanometers.

### Example Use Cases

### Transport Energy Using Capacitors (or Stable Batteries)

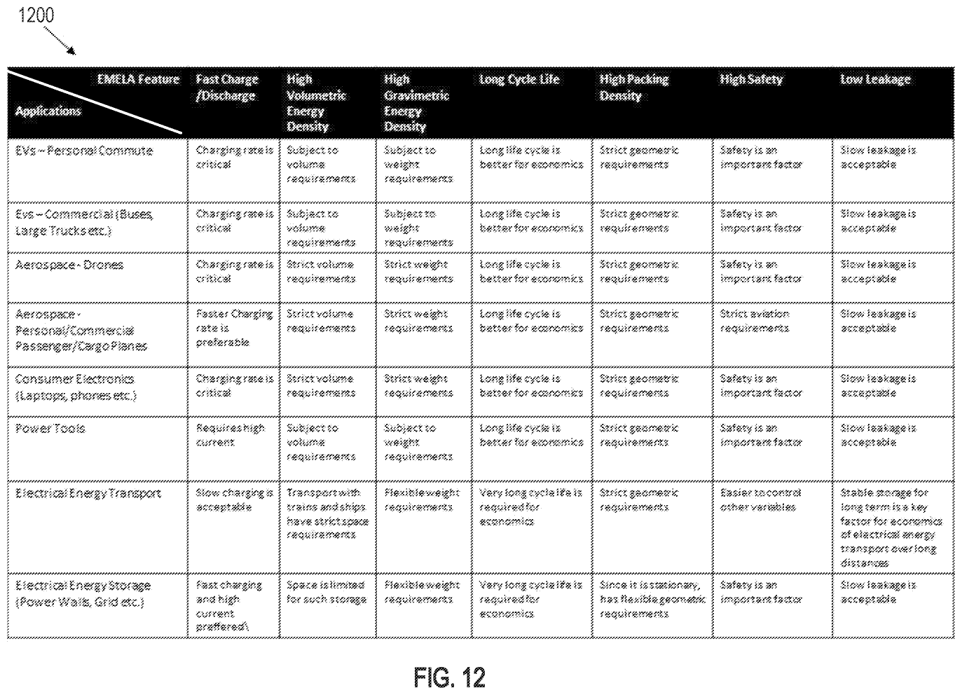

FIG. 12 is a diagram 1200 illustrating a set of benefits (advantages) of the EMELA geometry and a set of applications for which EMELA batteries may be used. For example, as discussed above, the EMELA geometry may provide and/or allow for a charging/discharging rate that is much higher than a charging/discharging rate achievable by conventional batteries. Diagram 1100 illustrates that high charging/discharging rates are important and/or critical for electric vehicles (personal or commercial), drones, airplanes (personal, passenger, or cargo), consumer electronics, power tools, and or electrical energy storage. For example, the ability to charge an electric vehicle in a same amount of time as it takes to fill a gas tank may be important to the adoption of electric vehicles. On the other hand, fast discharging may allow for high power applications (e.g., power tools). In other applications for which fast charging/discharging may be less important, the EMELA geometry may allow for the use of less stringent fabrication techniques that may be less costly or provide other benefits.

Additionally, the EMELA geometry may provide and/or allow for a high volumetric and/or gravimetric energy density that is much higher (e.g., by a factor of 100-1000) than a volumetric and/or gravimetric energy density achievable by conventional batteries as indicated in FIG. 11. Additionally, high packing density may be combined with the high volumetric and/or gravimetric energy density to achieve scalable batteries that may be utilized across applications with different size requirements. Diagram 1100 illustrates that high volumetric energy density may be beneficial, important, and/or critical for electric vehicles (personal or commercial), drones, airplanes (personal, passenger, or cargo), consumer electronics, power tools, and or electrical energy storage. For example, for electric vehicles, and especially for aerospace applications, high volumetric and gravimetric energy densities may provide significant and/or critical benefits and allow for better performance or additional capacities to be incorporated into a vehicle or drone. The volumetric and gravimetric energy density may also allow for economic viability of electrical energy transport or storage.

The EMELA geometry may further allow or provide for an increased lifetime (e.g., an increased number of charge/discharge cycles maintaining a threshold charge/energy level) of a device using the EMELA geometry by a factor of 100-1000 or more. As discussed above in relation to FIGS. 8 and 10, the increased lifetime of the device using the EMELA geometry may be due to a decreased current density (e.g., based on an increased surface area and an omni-, or multi-, directional ion flow during a charging and/or discharging operation). Increased battery lifetime contributes to the economic viability of the battery and of the devices using the battery.

Currently gasoline and oil is transported all over the world. It is converted into energy by the engines at the site of use. On the other hand, electrical energy cannot be transported for long distances. In that sense, it needs to be generated through thermoelectrical, hydroelectrical, atomic energy, wind energy etc. Most often these power stations are located very close to where they are utilized because of the loses in the energy transport through the grid (cite literature). Another big problem is the storage. Storing these types of energy is only possible for very short time. In particular rechargeable battery chemistries like lithium ion chemistries are not reliable storage systems despite their high specific energy.

For energy transport volumetric energy density is much more important compared to gravimetric energy density. For instance, the ships, trains and trucks can carry high weight loads for long distances, however their volume is limited. The key parameter to achieve transporting electrical energy is stability, namely not losing charge for a long time.

Capacitors are very stable. When you charge a capacitor and disconnect the electrodes it can hold charge as long as the material itself does not degrade. However, their gravitational and volumetric energy densities are very low making their use for long term energy store not feasible. Supercapacitors are better in terms of energy density making it closer to the battery chemistries, however, they suffer greatly from the stability. A modern supercapacitor loses about 20% of its charge. Therefore, they cannot be used for this purpose.

In accordance with the present invention, the inventive EMELA capacitors are at least comparable or exceed the energy density capability of the prior art batteries. The inventive capacitors' stability is at least comparable to typical capacitors while their energy density gravimetric or volumetric would be at least comparable to the modern rechargeable battery chemistries. EMELA capacitors can be used to transport electrical energy over long distances, including across the globe. The inventive capacitors can be used to store electrical energy for a longer time even up to several years or more. This way electrical energy can be generated using various power stations including thermal, solar, hydroelectric, nuclear, wind at the sites where such means of energy generation is feasible. Then, this energy can be used to charge EMELA capacitors (or batteries although EMELA batteries are much more stable than typical rechargeable batteries, EMELA capacitors are still much more stable). Later these EMELA capacitors can be loaded on ships, trains, trucks to be transported some other part of the world. For instance, one can imagine a high surface area and low cost land like a desert, e.g., the Sahara Desert, to be covered with solar cell farms and the produced energy can be transported to places that consumes a lot of energy but limited sun exposure like New York City.

Thus, methods of transporting electrical energy across large geographic distances are provided herein, comprising generating electrical energy; storing the electric energy in an inventive EMELA capacitor or EMELA battery; and delivering said electrical energy to and end-user. The distance travelled for the delivery of the electric energy is selected from greater than: 50 mi, 75 mi, 100, mi, 150 mi, 200 mi, 250 mi, 300 mi, 350 mi, 400 mi, 450 mi, 500 mi, 600 mi, 700 mi, 800 mi, 900 mi, 1000 mi, 1250 mi, 1500 mi, 1750 mi, 2000 mi, 2500 mi, 3000 mi. 3500 mi, 4000 mi, 4500 mi. or 5000 mi, or more.

### Inductive Charging

As the charging rate increases dramatically, alternative ways are contemplated here in accordance with the present invention of charging in addition to conventional rates as the bottle neck becomes supplying the power to the energy storage device, capacitor or battery. This is important because in most cases the charging rates can be quicker than plugging in the charging cord to charge the device. For example, in order to handle large currents, much thicker charging cords are contemplated for us herein, which might make manual charging less practical. For such embodiments, it is contemplated herein to utilize automated systems and/or electrodes having a higher surface area to reduce the current density. The larger electrode surface area reduces current density, which thus helps materials withstand high total currents. In particular embodiments, electrodes with high surface areas are provided herein.

However, as the charging rates increases power applied by the charger/charging station is so high that in particular for applications requiring large batteries such as electrical vehicles to pull that much power from the grid becomes problematic. As the charge discharge rate increases it is reflected on the power density. The power density of the inventive EMELA devices is relatively high. In particular, the bottle neck is not the battery or the capacitor anymore; but rather the limitation is the power source itself. For these applications, it is contemplated herein to use an EMELA battery/capacitor. In these particular applications and/or embodiments, an inventive EMELA device can be charged prior to engagement with the battery/capacitor to be charged at a slower pace compatible with the capabilities of the grid. For example, an electric vehicle (EV) can engage with an already sufficiently charged charging station and once the engagement of EV is completed with the charging station, the energy transfer can be handled through inductive charging via “high surface area electrodes” that can withstand high current energy transfer.

As used herein, the phrase “high surface area electrodes” refers to any surface area that can withstand high current energy transfer. Exemplary high surface area electrodes include, for example, the entire under-carriage, frame, roof, and/or body of any vehicle; a large portion or the entire portion (all) of the back surface of a phone, and the like.

In another implementation, while an EV is moving on the freeway, there can be sections with inductive coils to wirelessly charge the cars passing through them. These coils can be periodically distributed through a particular lane. As hyper-fast energy transfer is required, these coils could be connected to an EMELA capacitor/battery, which is charged prior to the EV passing through it in a rate that the grid can handle. Having these coils connected to EMELA battery/capacitor distributed throughout the lane would ensure that the EV would be charged by a charged EMELA capacitor/battery that is in sufficiently charged state.

The inventive devices and methods are contemplated herein to advantageously change the operation of EVs. For example, current EVs are charged over a relatively long period of time; e.g., mostly overnight when they are parked. When they run out of battery they have to be charged in a charging station in a relatively long amount time. With the hyper-fast highway/freeway charging contemplated herein, the EV will be kept charged on the freeway and may not need to be ever need to drive by to a charging station.

Another convenient location for hyper-fast charging contemplated herein are traffic lights. When a car is waiting on the traffic light, it could stop on top of a coil. Considering most traffic lights stay at red in the range of minutes, it might be sufficient to charge an EMELA battery/capacitor at a slower pace much slower than their maximum charging rate. This will permit pulling the current directly from the grid and transferring via a coil wirelessly rather than charging an EMELA battery/capacitor prior to the engagement localized in the ground. If there are several traffic lights in the route, the EV does not need to be charged fully in each stop; it can be partially be charged at different stops.

Alternatively, there can be electrodes lifting up and touching the electrodes at a convenient location in the car such as the bottom undercarriage of the car. When a car stops over the zone, the sensors could detect the presence of the car and lift up the electrodes of the charging station to charge the EV with contact. This can be applied to wireless charging as well as the proximity improves the efficiency of the energy transfer. The automated lifts can bring up to coils to the close proximity of the coils of the EV to achieve energy transfer.

Other than, EVs hyper-fast charging would provide different implementations for other electronics such as smart phones. As hyper-fast charging can be achieved in a very short time frame around a fraction of seconds (microseconds, milliseconds, seconds, etc.), one can utilize hyper-fast charging surfaces in places like malls. Instead of plugging cables into the phone. Phones can be touched to a surface briefly to be charged.

For drones for various different applications, there can be landing zones for drones to briefly land on to be charged to go on their way. This would be very useful for drones that are used for delivery applications.

As the charging becomes much faster, it is contemplated herein to accelerate the monetary transfer for using such charging stations. RFID, Bluetooth based smart systems can be implemented assigning vehicles/devices a unique code for the monetary exchange via automated app/software with only very limited effort on the customer side.

### Deep Hole Array Embodiments

In a particular embodiment, a “deep array” or “deep hole array” silicon anode (e.g., the DPASS) is used as a continuous conductive substrate (PCS, the CCS, or the PM). A deep hole array, in some aspects, has high density cylindrical pores that go as deep as 300-1000 microns. Also provided herein is inventive separator chemistry that is directly applied on the silicon, and coats the entire internal surface area of the silicon. The thickness of the non-electrically-conductive separator layer (also referred to herein as the separator or separator membrane), in particular embodiments, is <5 microns; and in a particular embodiment the target thickness is 1 micron. In other embodiments, the thickness of the separator membrane is <(less than) 6, 7, 8, 9, 10, 11, 12, 13, 14, 15, 16, 17, 18, 19, or 20 microns.

In one embodiment, the silicon itself is highly doped providing a good conducting medium. In this embodiment, an additional carbon coating or carbon black network of particles is not required because the high doping of entire medium provides sufficient electrical conductivity.

As used herein, the term “expansion” in the context of the inventive PCS, CCS, PM, or DPASS substrates provided herein, refers to the swelling of the respective substrate due to ion capture, such as lithium ion capture with silicon. For example, silicon usually swells or expands to around 300% due to lithium ion capture, which swelling of a substrate is referred to herein as the term “expansion”. This leads to shattering and cracking of silicon. One reason for that is the asymmetric diffusion of lithium ions in conventional geometry that swells silicon medium much more in the frontline portions that face the lithium ions first right after they pass the separator. In accordance with the inventive geometry provided herein, as the cathode particles fill the hollow cylindrical pores, there is a more symmetric diffusion of lithium ions into the silicon, so that because of the dimensions utilized herein, there is enough surface area and very limited diffusion thickness for lithium ions to find empty spots. Accordingly, the swelling is contemplated to advantageously be minimal usually around 5-20%, which limits cracking and shattering. In other embodiments, the amount of expansion or swelling of the respective substrates is no greater than the range of: 1%, 2%, 3%, 4%, 5%, 6%, 7%, 8%, 9% 10%, 11%, 12%, 13%, 14%, 15%, 16%, 17%, 18%, 19%, 20%, 21%, 22%, 23%, 24%, 25%, 30%, 35%, 40%, 45%, 50% of the starting volume of the substrate

In particular embodiments, the non-electrically-conductive separator layer 1551 (also referred to herein as separator, separator membrane or membrane) is selected to be a flexible material that adapts shrinking and expanding of silicon medium. In one embodiment. provided herein is a separator comprising a polyethylenimine crosslinked by 1,4-butanediol diglycidyl ether. The separator is templated over the silicon substrate. In other embodiments, other suitable crosslinkers that can form a flexible material that adapts to the shrinking and expanding of silicon medium are contemplated for use herein. For example, in particular embodiments, the following separators are contemplated for use herein: Single-layer PE; Single-layer PP; Ceramic-coated PP; Trilayer PP/PE/PP; which are described in Lagadec et al., Nature Energy | VOL 4 16 | JANUARY 2019 | 16-25; which is incorporated herein by reference in its entirety for all purposes.

In other embodiments, additional separator layer materials for use herein are disclosed in Tables 4-12 of Costa et al, Energy Storage Materials 22 (2019), pgs 346-375 (which is incorporated herein by reference in its entirety for all purposes); and in Tables 1-9 herein.

TABLE 1
Glass transition temperature of the main polymer
types used for single polymer membranes.

| Polymer | Glass transition temperature (° C.) |
|---|---|
| PE | −125 (LDPE) and −110 (HDPE) |
| PP | 6 |
| PEO | −51 |
| PAN | 80-145 |
| PVDF | −40 |
| PVDF-HFP | −35 |

TABLE 2
Microporous type separator membranes from different polymer matrices and their main characteristics for battery applications.

| | | Conductivity | | |
|---|---|---|---|---|
| | | (mS · cm⁻¹) and | | |
| Materials | Electrolyte solution | capacity (mAh · g ¹) | Anode/cathode | Main achievement |
| PP | 1M LPF₆ in EC:DMC | 0.16; 141 (0.1C) | Li metal/LiCoO₂ | Increase degree of porosity |
| PVDF-CTFE | 1M LiTFSI in PG | 1.5; 92 (2C) | Li metal/LiFePO₄ | Good cyclability |
| PVDE | 1M LiPF₆ in EC:DMC:DEC | 1.72; 110.3 (5C) | Li metal/LiFePO₄ | and rate capability |
| | | | | Higher electrolyte uptake and |
| | | | | improved uptake rate |
| PVDF-HFP | 1M LiPF₆ in EC:DMC | 0.36-4; −62.(C/ | Li metal/LiMn₂O₄ | Improved high temperature |
| PVDF-HFP | — | 5 at 55° C.) | Li metal/ | cycling performance |
| | | 1.08; 175 at 110° C. | Li(Ni_{0.8}Co_{0.1}Mn_{0.1})O₂ | Efficient migration of |
| | | | | electrolyte salts |
| PVA | 1M LiPF₆ in EC:DEC (1:1, | 1:20; 84.3 (4C) | Li metal/LiFePO₄ | Improved electrochemical |
| | v:v) | | | performance |
| Cellulose | 1M LiClO₄ in EC:DEC (1:1, | ~0.8; 100 (1C) | Graphite/LiFePO₄ | High porosity, wettability |
| | v:v) | | | and mechanical robustness |
| PI | 1M LiPF₆ in EC:DMC:EMC | :2.15; 110.4 (0.5C) | Graphite/LiCoO₂ | High discharge capacity and |
| | | | | better rate capability |
| PAEK | 1M LiPF₆ in EC/DEG/EMC | 1.99; 121 (C) | Li metal/LiCoO₂ | Improved liquid electrolyte |
| | (1:1:1, v/v/v) | | | holding capacity than |
| | | | | PP membranes |
| Polybenzoxazole | 1M LiPF₆ in EC/DEC (1:1, | -; 103 (1C) | Graphite/LiCoO₂ | High power density |
| | v/v) | | | |
| Cladophora cellulose | 1M LiPF₆ in EC:DEC (1/1, | 0.4; 135 (0.2C) | Li metal/LiFePO₄ | Thermally stable at 150° C. |
| | v/v) | | | and electrochemically |
| | | | | inert between 0 and |
| | | | | 5 V vs. Li+/Li. |
| Poly(m-phenylene | 1M LiPF₆ in EC/DMC/ | 1.5; 108.7 (0.5C) | Graphite/LiCoO₂ | High-heat resistance |
| isophthalamide) (PMIA) | EMC (1:1:1, wt/wt/wt) | | | and high-power density |
| | | | | lithium-ion batteries |
| PI | 1M LiPF₆ in EC:DEC (1/1, | -;- | Li metal/LiFePO₄ | Early alarms of Li penetration |
| | v/v) | | | |
| PPTA | 1M LiPF₆ in EC:DEC (1/1, | 0.21; ~110 (C) | Graphite/LiCoO₂ | Good electrolyte wettability, |
| | v/v) | | | excellent mechanical properties, |
| | | | | and superior thermal stability |
| PEEK | 1M LiPF₆ in EC/DMC/ | 0.11; 124.1 (5C) | Li metal/LiFePO₄ | High thermal stability and |
| | EMC (1:1:1, v/v/v) | | | good rate capability |
| OHPEEK | 1M LiPF₆ in EC/DME | -; 90 (4G) | Li metal/ | High anti shrinkage property |
| | | | LiNi_{0.5}Mn_{0.2}Co_{0.3}O₂ | and high thermal stability |
| PI | 1M LiPF₆ in EC/DEC (1:2, | -; 125.3 [0.1C) | Li metal/LiCoPO₄ | Improved coulombic efficiency |
| | v/v) | | | and capacity retention |
| PBI | 1M LiPF₆ in EC/DMC/ | 0.13; 154.5 (0.2C) | Li metal/LiFePO₄ | High thermal stability and |
| | EMC (1:1:1, v/v/v) | | | electrolyte wettability |
| OPBI | 1M LiPF₆ in EC/DEC (1:1, | 1.03; 160 (0.10) | Li metal/LiFePO₄ | Only ~5% thermal shrinkage |
| | v/v) | | | after heating at 200° C. |
| | | | | for 1 h and good fire |
| | | | | retardant properties |
| Cladophora cellulose | 1M LiPF₆ in EC:DEC (1/1; | 0.82; 125 (C) | Li metal/LiFePO₄ | Enhanced battery performance, |
| | v/v) | | | particularly at higher |
| | | | | cycling rates |
| PPC | — | 0.22; 140 (0.1C) | Li metal/LiFePO₄ | Excellent electrochemical |
| | | | | stability at ambient temperature |
| PVA | 1M LiPF₆ in EC:DEC (1/1, | 1.41; ~140 (0.5C) | Li metal/LiFePO₄ | Improved safety and matched |
| | v/v) | | | electrochemical performance. |

TABLE 3
Nonwoven membranes from different polymer matrices and their main properties as battery separators.

| | | | Conductivity | | |
|---|---|---|---|---|---|
| | | | (mS · cm⁻¹) and | | |
| Materials | Method preparation | Electrolyte solution | capacity (mAh · g⁻¹) | Anode/Cathode | Main achievement |
| PEGDMA/PET | wet-laid | 1M LiPF₆ In EC-DMC | 2.14; — | — | Higher porosity, good |
| | | (1:1 v/v) | | | chemical stability |
| PP/SiO₂ | melt-blown | 1M LiPF₆ In EC-DMC | 4.33; 152 (0.2C) | Li metal/LiFePO₄ | Higher capacity value |
| PVDF/SiO₂ | melt-blown | 1M LiPF₆ in EC/DMC/ | —; 170 (0.2) | Li metal/LiCoO₂ | Better cycling performance |
| | | EMC 1:1:1 | | | |
| PVDF-HFP/ | casting solution into | 1M LiPF₆ in EC/DMC/ | 3.45; 122 (10C) | Li metal/LiCoO₂ | Excellent interface |
| SiO₂ | nonwoven | EMC 1:1:1 (vol) | | | compatibility |
| | | | | | and capacity retention |
| PI | in-situ polymerization | 1M LiPF₆ In EC/DMC/ | 2.7; 108.4 | Graphite/LiCoO₂ | Internal short circuit |
| | and cross-linking | EMC 1:1:1 (wt) | | | protection and stable |
| | reaction | | | | Interfacial resistance |
| Bacterial | Soaked and | 1M LiPF₆ in EG/DMG/ | 4.91; 161 (0.2G) | Li metal/LiFePO₄ | Large porosity and |
| cellulose/ | hot-pressed | DEC (1/1/1, v/v/v) | | | improved electrochemical |
| Al₂O₃ | | | | | stability |
| Alginate | — | — | 1.4; 98 (10C) | Li metal/LiNi_{0.5}Mn_{1.5}O₄ | Heat resistant and excellent |
| | | | | | cycling stability |
| PET | — | 1M LiPF₆ In EC/EMC | 0.6; 1.75 mAh (4C) | Graphite/LiCoO₂ | Higher electrolyte |
| | | (3:7 by vol) | | | uptake and ionic |
| | | | | | conductivity value |
| PVDF-HFP | wet laid | 1M LiPF₆ In EG/DEC/ | 1.2-1.8; 130 (1C) | Graphitized | Better rate capability |
| | | EMC (1/1/1, v/v/v) | | mesocarbon | and long-term stability |
| | | | | microbeads/LiCoO₂ | |
| PVDF-HFP/ | dip-coating | 1M LiPF₆ in DMC/ | 1.20; 131.33 (5C) | mesocarbon | Superior thermal stability, |
| PET | | EMC/EC (1:1:1, v/v/v) | | microbeads/LiNi_{1/3} | and higher |
| | | | | Co_{1/2}Mn_{1/3}O₂ | electrolyte uptake |
| PET/cellulose | wet-laid | EC/DEC | 160 (0.2C) | Li metal/LiFePO₄ | High mechanical strength |
| | | | | | and hydrophilicity |
| Ester/Al₂O₃/ | coating | 1M LiPF₆ in BC/EMC | 0.824; 100 (0.2C) | Graphite/Li(Ni_{1/3} | Stable up to 200° C. |
| PET | | (30:70, v/v) | | Co_{1/3}Min_{1/3})O₂ | |

TABLE 4
Electrospun membranes from different polymer matrices and their main properties as battery separators.

| | | | Conductivity | | |
|---|---|---|---|---|---|
| | | | (mS · cm⁻¹) | | |
| | Solvent and electrospinning | | and capacity | | |
| Materials | conditions | Electrolyte solution | (mAh · g ¹) | Anode/Cathode | Main achievement |
| PAN | DMF, 17 wt % of PAN, 13 kV, | 1M LiPF₆ in EC/DMC (1:1) | 0.935; 154 | Li metal/LiFePO₄ | High tensile strength and thermal |
| | 11 cm, 1 ml/h | | (1C) | | stability. High electrolyte uptake |
| | | | | | and ionic conductivity. |
| PAN/SiO₂ | DMF, 10 wt % of PAN, 16 kV, | 1M LiPF₆ in EC/EMC (1:1) | 2.6; 82 (8C) | Li metal/LiFePO₄ | Improved electrochemical oxidation |
| | 25 cm, 0.75 ml/h | | | | limit, and low interfacial resistance |
| | | | | | with lithium |
| PI | DMF, 10 wt % of polymer, | 1M LiPF₆ in EC:DMG: | 3.83; 147 | Li metal/LiFePO₄ | 5.3 V electrochemical window and |
| | 15-25 kV, 30 cm, 0.3 ml/h | EMC, 1:1:1 | (0.2C) | | low electrode-electrolyte interfacial |
| | | | | | resistance. |
| PVDF | DME, 16 wt % of PVDF, 10 kV, | 1M LiPF₆ in EC:DEC: | 8.36; 115 | Li metal/LiMn₂O₄ | Improved wettability, higher |
| | 10cm, 100 μl/h | DMC, 1:1:1 (w/w/w) | (0.2C) | | thermal shrinkage and excellent |
| | | | | | discharge capacity |
| PVDF | DMF/acetone, 12.5 wt % of | 1M LiPF₆ in EC/DMC (1/1 | 3.47; ~140 | Graphite/ | Shows the relevance of the separator |
| | PVDF, 22 kV, 20 cm, 0.6 ml/h | by vol) and 1:2 M LiPF6 in | (0.5C) | LiNi_{0.8}Co_{0.15} | thickness in preventing short circuit |
| | | EC/EMG/DMC/DEC = 30/ | | Al_{0.05}O₂ | by reducing pore size. |
| | | 10/40/20 (vol) | | | |
| PI/PVDF/PI | DMF/acetone, 16 wt % of PVDF, | 1M LiPF₆ in EC/DMC/DEC | 3.46; 115 | Li metal/LiMnO₂ | Improved electrolyte uptake and |
| | 10 kV, 10 cm, 100 μl/h (PI) and | (1:1:1, wt/wt/wt) | (0.5C) | | ionic conductivity |
| | 125 μl/h (PVDF) | | | | |
| PVDF/MMT | DMF/acetone, 15 wt % of PVDF, | 1M LiPF₆ in EG/EMG/DEC | 4.2; 128.5 | Li metal/LiFePO₄ | Reduced interfacial resistance and |
| | 12 kV, 15 cm, 0.72 ml/h | (1:1:1, v/v) | (1C) | | excellent electrochemical stability. |
| PVDF | DMAC/MEK, 10 wt % of PVDF, | — | — | — | Thennal and dimensional stability. |
| | 11 kV, 12 cm. | | | | |
| PVDF/PAN | DMF | 1M LiPF₆ in EC/DMC/ | 1.51; 147.7 | Li metal/LiFePO₄ | High electrolyte uptake, excellent |
| | | EMC, 1:1:1 vol | (0.2C) | | dimensional stability and improved |
| | | | | | mechanical strength. |
| PVDF | DMF/acetone, 13 wt % of PVDF, | 1M LiPF₆ in EC/DMC/EMC | 1.48; 136 | Li metal/LifePO₄ | High porosity, thermal dimensional |
| | 10 kV, 15 cm, 1 ml/h | (1:1:1, v/v/v) | (0.2C) | | stability and good compatibility |
| | | | | | with liquid electrolyte |
| PVDF/PAN/ | DMF, 15 kV, 15 cm | 1M LiPF₆ in EG/DMC/EMC | 1.68; 140 | Li metal/LiFePO₄ | Superior discharge capacity and |
| SiO₂ | | (1:1:1, v/v/v) | (1C) | | cyclic performance even at elevated |
| | | | | | temperatures |
| PVDF/ | DMF/acetone, 12 wt % of PVDF, | 1M LiPF₆ in EC/DMC/EMC | 4.2; 145.8 | Li metal/LiCoO₂ | High ionic conductivity and |
| Octaphenyl- | 20 kV, 25 cm, 0.5 mm needle | (1:1:1, v/v/v) | (0.1C) | | electrochemical window of 5.6 V |
| POSS | diameter | | | | |
| PVDF/PAN | DMF, 15 kV | 1M LiPF₆ in EC/DMC/ | 1.45; 145.7 | Li metal/LiFePO₄ | High electrolyte uptake and ionic: |
| | | EMC (1:1:1, v/v/v) | (0.2C) | | conductivity |
| PVDF/ | NMP/acetone, 16 wt % of PVDF | 1M LiPF₆ in EC/DMC/DEC | 2.23; 120 | Li metal/LiMn₂O₄ | Superior thermal stability |
| Al₂O₃ | | (1:1:1, wt/wt/wt) | (0.5C) | | |
| PVDF-HFP/ | PET:TFA/DCM solvents, 3:2 v/ | 1M LiPF₆ in EC/DEC (1:1, | 6.39; 158 | Li metal/LiFePO₄ | High porosity, superior electrolyte- |
| PET/PVDF- | v, 16 wt % of PET, 20 kV, 20 | v/v) | (0.1C) | | philic properties and excellent |
| HFP | cm, 0.09 ml/min, 0.26 mm. | | | | electrolyte uptake. |
| | PVDF-HFP:DMF/acetone, 5 wt | | | | |
| | % of PVDF-HFP | | | | |
| PAN/lignin | DMF, 12 wt % of PAN, 19 kV | 1M LiPF₆ in EC + DMC | 1.24; 148.9 | Li metal/LiFePO₄ | Superior discharge rate capability |
| | and 4 kV, 19 cm, 2 ml/h and | (vol) | (0.2C) | | and cycling performance |
| | 120 rpm of collector drum | | | | |
| | rotation speed | | | | |
| Al₂O₃/ | DMA/acetone, 25 wt % of | 1M | 1.4; 105 | Li metal/LiMn₂O₄ | Thermal/dimensional stability and |
| PVDF | PVDF, 10 kV, 5 μl/min | LiPF₆ in EC/DEC = 1/1 | | | mechanical flexibility |
| | | v/v | | | |
| PI/SiO₂/ | 16.5 kV, 15 cm, 0.1-0.3 ml/h | 1M LiPF₆ in EC/DMC = 1/1 | 169 (0.1C) | Li metal/LiCoO₂ | No shrinkage and no melting up to |
| Al₂O₃ | | v/v | | | 200° C. |
| PMIA | DMAc, 14 wt % of PMIA, | 1M LiPF₆ in EC/DMC = 1/1 | 2.04; 145 | Li metal/LiCoO₂ | Low electronic conductivity and |
| | 27 kV, 19 cm, 0.2 ml/h | v/v | (0.5C) | | interfacial resistance, high |
| | and 0.45 mm | | | | electrochemical stability window |
| PES | DMF, 28 wt % of PES, 12 kV, | — | — | — | Tailorable porosity |
| | 10.5 cm, 20 μl/min-80 μl/min | | | | |
| PVDF-HFP/ | DMAc/acetone | 1M LiPF₆ in EC/DMC/EMC | 13.90; 155.3 | Li metal/— | Good wettability, high porosity and |
| Li_{0.33}La_{0.557} | | (1:1:1, v/v/v). | (0.2C) | | improved electrolyte compatibility |
| TiO₃ | | | | | |
| PANI/PI | DMAc, 10 wt % of polymer, | 1M LiPF6 in EC/EMG/DMC | 2.33; 133 | Li metal/LiFePO₄ | Improved thermal stability, good |
| | 20 kV. | | (0.2C) | | tensile strength and high |
| | | | | | electrochemical performance. |
| M-aramid | DMAc, 21 kV, 7 cm, 0.5 ml/h | 1M LiPF₆ in EC/DMC (1/1, | 1.3; 150 (1C) | Li metal/LiFePO₄ | Improved thermal stability and |
| | | v/v) | | | electrolyte wettability. |
| PES/PDA | DMF, 30 wt %, 18 kV, 20 cm | 1M LiPF₆ in EC/DMC (1/1, | —; 148.5 | Li metal/LiFePO₄ | Ultrahigh porosity, high liquid |
| | | v/v) | (0.5C) | | electrolyte uptake and superior |
| | | | | | liquid electrolyte wettability. |
| PAN/PU | DMF, 10 wt % of PAN, 12 wt % | 1M LiPF₆ in EC/EMC/DMC | 2.07; 169 | Li metal/LiFePO₄ | Stable cycling performance and |
| | of PU, 25 kV, 15 cm, 1 ml/h | (1/1/1, w/w/w) | (0.2C) | | good electrochemical stability |
| PA66 | Formic acid; 20 kV, 20 cm, | 1M LiPF₆ in EC/DEC (1/1, | —; 145 | Li metal/LiCoO₂ | Improved safety with respect to |
| | 0.35 ml/h | v/v) | | | commercial |
| | | | | | Separators at high temperature. |
| Melamine | Formaldehyde, 18.5 kV, 16 cm, | 1M LiPF₆ in EC/DMC (1/1, | 0.79; 110 | Graphite/LiMn₂O₄ | Improved thermostability and flame |
| resin | 1 mm | v/v) | at 55° C. | or LiFePO₄ | retardancy |
| PI | DMF/DMA; 15 kV, 0.2 ml/h, | 1M LiPF₆ in EC-DMC | 0.44; 124.6 | Li metal/LiFePO₄ | Good wettability, high ionic |
| | 0.5 mm | | (C/5) | | conductivity and cycling |
| | | | | | performance. |
| Lignin/PVA | Deionized water, 8 wt % of | 1M LiPF₆ in EC-DEC-FEC | —; 188.6 | Li metal/ | Flame retardant properties and high |
| | polymer, 26 kV, 25 cm, 1.2 mL/ | (5:70:25, v/v) | (0.1C) | Li(Ni_{0.33}Mn_{0.33} | ionic transport |
| | h, 0.82 mm | | | Co_{0.33})O₂ | |
| PI | DMAc, 15 wt % of PI; 15 kV; | 1M LiPF₆ in EC/DMC/EMC | 1.50; 104 | Li metal/LiFePO₄ | Improved electrochemical oxidation |
| | 15 cm, 0.45 ml h ¹, 0.51 mm | (1:1:1, w:w:w) | (5C) | | limit, lower interfacial resistance |
| PAN | DMF, 8 wt % of PAN; 17.5 kV, | LiPF6-EC/DMG/DEG | 1.05; 135 | Graphite/LiCoO₂ | Increased amorphous regions and |
| | 15 cm, 0.6-0.9 ml h⁻¹ | | (0.2C) | | excellent ionic conductivity and |
| | | | | | cycling performance |
| hBN/PAN | DMF, 8 wt % of PAN; 20 kV, | 1M LiPF₆ in EC/DEC (1/1, | 1; 144 (0.1C) | Li metal/LiCoO₂ | Improved safety. |
| | 20 cm, 2 ml h ¹ | v/v) | | | |
| PAN | DMF, 3% (w/v); 10kV, 15 cm, | LiPF₆ in EG/PG/DEC (3:2:5, | 3.9; 113 (5C) | Li metal/LiFePO₄ | Improved battery performance |
| | 30 μl/min | v/v) | | | |
| PSA | DMAc, 12 wt % of PSA; 18 kV; | 1M LiPF₆ in EC/DEC (1/1, | 1.06; 86.7 | Li metal/LiCoO₂ | Improved thermal stability and |
| | 15 cm, 0.2 ml min⁻¹ | v/v) | (4C) | | electrolyte wettability |
| PI | DMF, 12%; 22 kV | 1M LiPF₆ in EC/DEC/DMC | 3.14, 130 | Li metal/LiFeP₄ | Excellent cycling stability and rate |
| | | (1:1:1, v/v) | (5C) | | capability |
| PAN | DMF, 7, 9 and 12 wt %; 18 kV, | 1M LiPF₆ in.EC/DEC (1:1, | 0.59-1.06; | Li metal/LiMn₂O₄ | Higher Li⁺ ion permeability and |
| | 25 cm, 0.5 ml h ¹, | v/v) | 89.5 (C/2) | | discharge capacity |
| Matrimid | DMF, 12 wt %; 22 kV, 23 cm, | 1.0M LiPF₆ in EC/DEC/ | —; 100% | Graphite/LiCoO₂ | No thermal shrinkage |
| | 0.6 ml h ¹ | DMC (4/2/4 wt %) | | | |
| PLA/PBS | PLA solvent:HFIP, PBS solvent: | 1M LiPF₆ in EC/DEC/EMC, | 1.65; 93.7 | Graphite/LiFePO₄ | High thermal stability and excellent |
| | CF and o-chlorobenzal | 1/1/1, v/v/v | (1C) | | wettability |
| | Dehyde; 15 kV, 15 cm; | | | | |
| | 0.74 ml h ¹ and 0.9 mm for PLA | | | | |
| | and 1.68 ml h ¹ and 0.4 mm for | | | | |
| | PBS | | | | |
| Nylon 6.6/ | Formic acid, 18 wt %; 20 kV, | 1M LiPF₆ in EC/EMC, 1/1, | 3.3-3.6; 160 | Li metal/LiCoO₂ | Improved electrochemical oxidation |
| TiO₂ and | 12 cm, 1 ml h ¹ | v/v/ | (0.2C) | and Li metal/ | limit, and lower interfacial |
| SiO₂ | | | | LiFePO₄ | resistance |
| Chitin | — | 1M LiPF₆ in EC:DEC (1:1) | 0.066; 157 | Li metal/LiFePO₄ | High mechanical strength, excellent |
| | | | (0.1C) | | thermal stability, and good |
| | | | | | electrolyte |
| | | | | | wettability |

TABLE 5
Membranes with external surface modification from different polymer matrices and their main properties as battery separators.

| | | | Conductivity | | |
|---|---|---|---|---|---|
| | | | (mS · cm⁻¹) and | | |
| | | | capacity | | |
| Materials | Modification type | Electrolyte solution | (mAh · g⁻¹) | Anode/Cathode | Main achievement |
| PAN | Coating of SiO₂-MWCNT | 1M LiTFS1+ 0.1M LiNO₃ | 2.17; 627 (1C) | Li metal/Sulfur | Improved overall electrochemical |
| | | in DOL, DME | | | performance |
| PE | Coating of Pl and PVDF- | Electrolyte | 0.70; 107.5 (0.5C) | Graphite/LiMn₂O₄ | Better wettability and good cyclic |
| | HFP/Al₂O₃ | | | | performance |
| PVP/PAN | Coating of Silica or | 1M LiPF₆ in EC/DMC (1/1 | 4.93; 200 (0.5C) | Li metal/LNMO | Improvements in:fast-rate:charge/ |
| or PEI | MWCNT | (v/v) | | | discharge |
| PET | Coating of ZrO₂/ | 1M LiPF₆ in EC + DEC (1/ | 1.48; 100 (2C) | Li metal/LiFePO₄ | Improved cell performance |
| | PVDF-HFP | 1, v/V) | | | |
| PP | Coating of 87.5 wt % of | 1M LiTFSI + 0.25 M LiNO₃ | —; 1267 (0.2C) | Li metal/Sulfur | Superior polysulfide affinity and |
| | carbon-material and 12.5 | in DOL:DME (1:1 v/V) | | | electrochemical performance |
| | wt 3% of PVDF binder | | | | |
| PE | Coating of Al₂O₃ | 1M LiPF₆ in EC/DEC (1:1, | ~0.8; 120 (1C) | Graphite/LiCoO₂ | Enhanced moisture repulsion |
| | | v/v) | | | |
| PP | Coating of Al₂O₃/PVA | 1M LiPF₆ in EG/DEC/DMC | 15.1 Ωm; 180 | Li metal/ | Increaseds pore tortuosity |
| | | (1:1:1 by vol) | (0.1C) | LiNi_{1/3}Co_{2/3}Mn_{1/3}O₂ | |
| PP | Coating of ZrO₂ and PDA/ | 1M LiPF₆ in EC/DEC/ | 1.61, 159.4 (0.1C) | Li metal/LiFePO₄ | Excellent thermal stability and low |
| | PEI | DMC, 1:1:1 by vol | | | interfacial impedance |
| PET | Plasma, NaOH treatment | 1M LiPF₆ in EC/DMC (1/1, | 0.17; 120 (1C) | Li metal/LiFePO₄ | Tower thermal shrinkage, higher |
| | and PA6 coating | v/v) | | | electrolyte affinity |
| PI | alkali treatment | 1M | 2.5; 70 (5C) | Graphite/LiCoO₂ | Improved lithium ion transference |
| | | LiPF, in EC/DMC/EMC (1/ | | | number |
| | | 1/1 wt/wt/wt) | | | |
| PP | Coating of PEO and PAA | 1M LiPF₆ in DEC/EC/DMC | 0.27; 307.9 (0.1C) | Li metal/LiFePO₄ or | High Li-ion conductivity |
| | | (1:1:1 vol) | | Li_{1.2}Mn_{0.54} | |
| | | | | Co_{0.13}Ni_{0.15}O₂ | |
| PE | Coating of TiO₂-PMMA | 1M LiPF₆ in EC/DMC, 1:1 | 0.87; 110 (2C) | Li metal/LiFePO₄ | Thermal shrinking resistance |
| | | in vol | | | |
| PE | Coaring of SiO₂-PMMA | 1M LiFF₆ in EC/DEC, | | Silica/Li metal | Improvement in lithium dendrite |
| | | 1:1 wt/wt | | | inhibition |
| PET | Coating of SiO₂- | 1M LiPF₆ in EC + DEC (1/ | 2.57; 90 (8C) | Li metal/LiFePO₄ | Excellent discharge C-rate |
| | PVDF-HFP | 1, v/v): | | | capability |
| PET | Coating of Al₂O₃ | 1M LiPF₆ in EC/EMC/DEG | 1.13:70 (20C) | Mesocarbon | Higher porosity and ionic |
| | | in 1:1:1 (by vol) | | microbeads/LiNi_{1/3} | conductivity |
| | | | | Co_{1/3} | |
| PSx-PEOS | Coating of PVDF-HFP | 1M LiTFSI + 0.7M LiBOB | 0.42; 80 (4C) | Li metal/LiFePO₄ | Enhanced ion transport |
| | | in EC/DMC (1:1 by wt) | | | |
| PP | Coating of SiO₂/ | 1M LiPF₆ in DMC/EMC/ | 0.85; 100 (4C) | Graphite/Li (Ni_{1/2} | Improved thermal stability and |
| | PVDF-HIFP | EC/VC 46.08/22.91/ | | Co_{1/3} | wettability |
| | | 27.22/3.79 in vol | | | |
| Cellulose | Coating of PVDF | 1M LiFF₆ in EC/DMC (1:1 | 1.25; 110 (C/5) | Graphite/Li (Ni_{1/2} | Improved rate capability |
| | | by vol) | | Co_{1/3} | |
| | | | | Mn_{1/3})O₂ | |
| PVDF | Plasma treatment | 1M LiPF₆ in EC:DMC | — | — | Increased electrolyte uptake |
| | | (1:1 w/w) | | | |
| Hydroxyethyl | Coating of PVDF | 1M LiPF₆ in EC/DMC/EMC | 0.86; 145 (0.2C) | Li metal/LiFePO₄ | High lithium ion transference |
| cellulose | | (1/1/1, w/w/w) | | | number |
| PVDF HFP | Coating of SiO₂ | 1.15M LiPF₆ in EC/EMC | 0.81; 170 (0.5C) | Graphite/Li (Ni_{1/3} | Improved wettability |
| | | (3:7 by vol) | | Co_{1/3} | |
| PE | Coating of SiO₂ and | 1M LiPF₆ in EC:DMC (1:1, | —; 121 (2C) | Li metal/LiFePO₄ | Good C-rate capability |
| | SBA-15-PVDF | vol) | | | |
| PE | Coating of PAA/ZrO₂ | 1M LiPF₆ in EC/DMC/EMC | 0.51; 115 (2C) | Li metal/LiCoO₂ | Larger Li⁺ transference number and |
| | | (1/1/1, w/w/w) | | | a stable SEI layer |
| PE | Coaring of Al₂O₃/PVDF- | 1M LiPF₆ in EC:DEC:PC: | 0.93; 160 (0.50) | Li metal/LiCoO₂ | No thermal deformation |
| | HFP-CMC | EMC-2:3:1:3 by vol | | | |
| PE | Coating of cellulose | 1M LiPF₆ in EC-DEC-EMC | 0.624; −120 (1C) | Li metal/LiCoO₂ | Electrolyte wettability and the |
| | diacetate-SiO₂ | (1/1/1 by wt) | | | thermal stability |
| PE | Grafting of TiO₂ | 1M LiPF₆ in EC-DMC-DEC, | 0.5; 135 (0.2C) | Graphite/LiFePO₄ | Thermal stability and better |
| | | 1.1:1 v/v/v | | | electrochemical performance |
| PE | Coating of ZrO2-POSS | 1M LiPF₆ in EC/DEC/EMC, | 0.46; 90 (7C) | Li metal/LiCoO₂ | Excellent electrochemical |
| | | 1/1/1, by wt | | | performance and safety |
| PE | Plasma treatment | 1.15 M LiPF₆ in EC-DEC, | —; 140 (1C) | mesocarbon | Improved thermal stability and |
| | | 1:1 (v/v) | | microbeads/LiCoO₂ | mechanical strength of separators |
| | | | | and LiNi_{0.6}Co_{0.2} | |
| | | | | Mg_{0.2}O₂ | |
| PE | Coating of PDA/POS5 | 1M LiPF₆ in EC/DMC/ | 0.45; 150 (0.2C) | Li metal/LiCoO₂ | Improved stability of lithium/ |
| | | EMC, 1/1/1, by vol | | | electrolyte interface, suppression of |
| | | | | | lithium dendrites formation |
| PE | Coating of 45-47% Al₂O₃ | 1M LiPF₆ in EC-DEC, 1:1; | 1:48; ~9 Ah | Graphite/LiNi_{0.5} | High thermal stability |
| | and 52-54% SiO₂ | v/v | (0.5C) | Co_{0.2}O₂ | |
| PP/PE/PP | Coating of MWCNTs and | 1M LiN(CF₃SO₂)₂ in 1,3- | —; 600 (1C) | Li metal/Sulfur | Facilitates lithium-ion transport and |
| | MgAl₂O₄ | dioxalane and DME (1:1, v/ | | | suppresses shuttling of polysulfides |
| | | v) | | | |
| PP | Atmospheric pressure | 1M LiPF₆ in EC/DEM/ | —; 120 (1C) | Li metal/LifePO₄ | Higher capacity and better C-rate |
| | glow discharge plasma jet | EMC; 1/1/1, by wt | | | capacity |
| PP | Coating of nano-SiO₂-PVA | 1M LiPF₆in EG/DMG/ | 1.26; 130 (1C) | Li metal/LiCoO₂ | Enhanced wettability and thermal |
| | | DEG, 1/1/1, by vol | | | stability |
| PP/PE/PP | Coating of SiO₂ | 1M LiPF₆ in EC/PG/DMC | 0.44; 160 (0.1C) | Li₄Ti₅O₁₂/Li metal | Highly porous structure and |
| | | with a weight ratio of 1:1:1. | | | favorable wettability |
| PP | Coating of CaF2/GO | 1M LiTFSI in DOL/DME | —; 1000 (1C) | Li metal/Sulfur | No insulating layer of solid Li₂S₂/ |
| | | (1:1 by vo) + 1 wt % LiNO₃ | | | Li₂S |

TABLE 6
Main characteristics and properties of the different filler types used for the development
of polymer composite Li-ion electrolyte membranes.

| | | Polymer | | Main effect on |
|---|---|---|---|---|
| Class | Types | matrix | Main characteristics | the membranes |
| Inert | SiO₂, TiO₂, Al₂O₃ | PVDF-HFP | Electrically and | Enhances ionic |
| ceramic | | PEO | thermally insulating | conductivity, Increases |
| oxides | | PVDF | | amorphous phase |
| | | PMMA | | and mechanical |
| | | PAN | | properties |
| | | PP | | |
| | | PE | | |
| | | PS | | |
| | | (Polystyrene) | | |
| | | Cellulose | | |
| | | PVDF-TrFE | | |
| | | PVP | | |
| Ferroelectric | BaTiO₃ | PEO | High dielectric constant | Increases lithium |
| | | PVDF-HFP | | transport number, |
| | | PVDF-TrFE | | improves lithium/ |
| | | | | electrolyte interface. |
| Super acid | CaCO₃, AlI₃, AlPO₄, | PMMA | Strong acidic centres | Improves ionic |
| oxides | Fe₂O₃, Zr-O-SO₄, | PEO | for interaction with | conduction process and |
| | BN, SN, | PVDF-HFP | polymer atoms | interfacial interactions |
| | NiO, CuO | PE | | between cell |
| | | PAN | | constituents |
| Clays | MMT | PVDF-HFP | Large surface area and | Improves the ionic |
| | | PEO | high thermal stability | conductivity and the |
| | | PAN | | uptake values |
| | | PMMA | | |
| | | PVDF | | |
| Carbonaceous | CNT | PEO | High surface area, high | Improves the thermal |
| fillers | | PVDF-HFP | electrical conductivity | stabilization of the |
| | | PVDF-TrFE | and excellent thermal | ionic conductivity and |
| | | | and mechanical | serves as mechanical |
| | | | properties | reinforcement |
| Molecular | ZSM, NaY, SBA-15, | PVDF-HFP | Three-dimensional | Improves electrolyte |
| sieves | MCM-41, MOF-5 | PEO | framework structure, with | uptake and increases |
| and zeolites | ZIF-67 | PP | large pore sizes in the | ionic conductivity. |
| | | PVDF | order of Å, high thermal | |
| | | | and hydrothermal | |
| | | | stability and high | |
| | | | external surface | |
| Lithium fillers | LiAlO₂, Li₂O, LATP, | PEO | High lithium-ion | Higher electrochemical |
| | LLTO, LiAlO₂ | PE | conductivity | cell performance |
| | | PVDF-HFP | | and improves interfacial |
| | | PAN | | properties with |
| | | | | lithium electrodes. |

TABLE 7
Separator membranes developed with different polymer composites and their corresponding application as battery separators.

| | | | Conductivity | | |
|---|---|---|---|---|---|
| | | | (mS · cm⁻¹) and | | |
| | | | capacity | | |
| Materials | Filler | Electrolyte solution | (mAh · g⁻¹) | Anode/cathode | Main achievement |
| PAN | TEOS:PSZ | LiPF₆ in EC:DMC: | 1.04; 121 (0.20) | Graphite/LiCo₂ | Ceramic domains leading increased |
| | | DEC | | | amorphous regions within the fiber. |
| PAN | Silica | 1.15M LiPF₆ in EC | 2.1; 162.1 (0.5C) | Graphite/ | Good electrolyte wettability and |
| | | EMC/DEC (3:5:2 by | | LiNi_{0.6}Co_{0.6}Mn_{0.2}O₂ | excellent thermal stability. |
| | | vol) + 5.0 wt % FEC | | | |
| PEO | TiO₂ | — | 0.0211; — | — | Improved thermal stability and |
| | | | | | mechanical integrity |
| PEO | EMImTFSI | — | 10; — | — | Improved ionic conductivity |
| PEO | LIZO | — | 5-10⁻⁵ S/cm at 80° C. | — | Decrease of the degree of crystallinity. |
| PEO | SiO₂ | 1M LiPF₆ in EC:DEC | 2; 96(5C) | Li metal/LiFePO₄ | High-performance lithium-ionic |
| | | | | | conductor and reliable separator for |
| | | | | | lithium metal batteries. |
| PEO | | 1M LiPF₆ in EC:DEC | 154.9 (0.1C) | Li metal/LiFePO₄ | Higher thermal and electrochemical |
| | | | | | stability. |
| PEO | LiTFSI and | — | 2.43; 107 (0.02C) | Li metal/LiNi_{1/3} | Electrochemically stable |
| | PYR₁₃FSI | | | Mn_{1/3}Co_{1/3}O₂ | up to 4.5 V (vs. Li/Li⁺). |
| P(AN-VAC)- | TiO₂ | 1M LiPF₆ in EC:DMC: | 4.5; 84 (20C) | Graphite/LiFePO₄ | Suppresses anion decomposition to |
| PMMA | | DEC | | | improve the stability and |
| | | | | | lifespan of the batteries. |
| PMMA | IL-TFSI | — | 0.512; 120 (C) | Li₄Ti₅O₁₂/Li metal | Excellent elasticity |
| | | | | | with large elongation- |
| | | | | | at-break (up to 1600%) |
| β-iPP | SiO₂ | EC:DEC (1:1) | — | — | Lower thennal shrinkage and shrinkage |
| | | | | | rate and suppressed porosity. |
| PP | SiO₂ | 1M LiPF₆ in EC/DMC | 0.63; 100 (8C) | Li metal/LiFePO₄ | Decreases the polarization of Li-ion |
| | | (1:1) | | | batteries and leads to improved power |
| | | | | | performance and cycle stability. |
| PVDF-HFP | LLZO | 1.15M LiPF₆ in EC/ | 1,3; 148.8 (0.5C) | Graphite/LiCoO₂ | Improved thermal stability |
| | | DEC, 3:7 by vol | | | and high ionic conductivity. |
| PVDF | nanoclays | 1M LiPF₆ in RC/DMC | — | — | Enlarged pore size and |
| | | (1:1) | | | reduced degree of crystallinity. |
| PVDF | NCC | 1M LiPF₆ in EC/DMC | 2.53; — | — | Mechanical reinforcement, associated |
| | | (1:1) | | | with a lower strain at break. |
| PVDF-HFP | BMimNfO | — | 26.1 at 100° C.; 126 | Li metal/LiCoO₂ | Enhancement of the electrical behavior. |
| | | | (C/4) | | |
| PVDF-HFP | PDA | 1M LiPE, in. EC:DMC: | 1.4; 105 (0.5C) | — | Excellent cyclic stability and good rate |
| | | DEC | | | performance. |
| PVDF-TrFE | MMT, NaY, | 1M LiTFSI in PC | 0.45; 103.1 (2C) | Li metal/LiFePO₄ | Improvement of the overall |
| | BaTiO₃, | | | | electrochemical behavior of |
| | MWCNT | | | | the separator membranes. |
| PVDF-HFP | OIL-Br | 1M LiPF, in EC:DEC | 2; 152 (0.1C) | Li metal/LiFePO₄ | Improved safety and superior. |
| | | | | | performance. |
| PVDF-HFP | Graphene oxide | 1M LiPF₆ in EC:DEC: | 1.12; 118 (2C) | mesocarbon | Improved electrochemical, mechanical |
| | | EMC | | microbead/LiCoO₂ | properties and therinal stability. |
| PVDF-HFP | Silica | 1M LiTFSI in | 1.11; 108.6 (0.2C) | — | Good compatibility and dendrite-free |
| | | EMITFSI/ EC/PC | | | electrodeposition of lithium metal at |
| | | | | | intermediate current densities. |
| PVDF-HFP | ZrO₂ | 1M LiPF₆ in EC:EMC | 2.06; 149.7 (0.1C) | Li metal/LiCoO₂ | High electrolyte uptake, high ionic |
| | | (1:3) | | | conductivity and high electrochemical |
| | | | | | stability potential |
| PVDF | AlO(OH) | 1M LiPF₆ in EC/DEG | 1.72; 80 (C) | Graphite/LiCoO₂ | Superior wettability and thermal |
| | | (3/7 w/w) | | | stability. |
| PVDF | Si2-TiO2 | LiPF₆ or LiBOB | — | Gaphite/LiFePO₄ | Increase in battery capacity. |
| PVDF-HFP | ZrO₂ | 1M | 1; 123 (0.1C) | Li metal/LiFePO₄ | Improved interfacial and |
| | | LiPF₆ in EC:EMG | | | electrochemical properties. |
| | | (1:1) | | | |
| PVDF-HFP | SiO₂ | 1M LiPF₆ in BC/DMG | —; 127 (C) | Li metal/ | Excellent thermal stability and safety |
| | | (1:2, v/v) | | LiNi_{0.5}Mn_{1.5}O₄ | towards fire |
| PVDF-HFP | EMImNfO | | 18 at 100° C.; 164 | Li metal/LiCoO₂ | Improved thermal stability and |
| | | | (C/10) | | excellent electrochemical properties. |
| PVDF | ZIF-4 | 1M LiPF₆ in EC/DMC | 3.4; 155 (0.2C) | Li metal/Li[Ni_{1/3}Co_{1/3} | Larger liquid electrolyte uptake, higher |
| | | | | Mn_{1/3}]O₂ | retention, higher ionic conductivity |
| | | | | | and lower interfacial resistance. |
| PVDF-HFP | LATP | 1M LiTFSI with 0.25M | 0.88; 1614 | Li metal/Sulfur | Good ionic conductivity as well as the |
| | | LiNO₃ in DME/DOL | | | reduced polysulfide shuttle within the |
| | | (1/1, v/v) | | | cell. |
| PVDF | reduced | 1M LiTFSI and 0.1M | —; 1070 (0.2C) | Li metal/Sulfur | Enhancement of the cycling |
| | graphene oxide | LiNO₃ in a DME/DOL | | | stability and rate capability |
| | | (1:1 vol) | | | |
| PVDF-HFP | ZrO₂ | 1M LiPF₆ in EC:DEC: | 0.320; 165.7 (0.2C) | Li metal/ | Superior thennal stability and improved |
| | | EMC | | Li[Ni_{1/3}Co_{1/3}Mn_{1/3}]O₂ | electrochemical performance. |
| PVDF | Graphene | 1M LiPF₆ in EC:DEC: | 3.61; 149 (C) | Li metal/LiCoO₂ | Improved specific discharge |
| | | EMC | | | capacity and discharge performance. |
| PVDF | Al₂O₃ | 1M LiPF₆ in EC; DEC | 0.82; 154(0.2C) | Li₄Ti₅O₁₂/LiFePO₄ | High rate electrochemical performance |
| | | | | | and enhanced thermal stability |
| PVDF-HFP | Al₂O₃ | 1M LiPF₆ in EC; | 1.3at 80 °C; 155 | Li metal/LiFePO₄ | Excellent electrochemical performance |
| | | DMC-EMC with a ratio | (0.5C) | | and remarkable rate capacity. |
| | | of 30/15/35/20 + | | | |
| | | 2% VC. | | | |
| Melamine | glass | 1M LiPF₆ in EC/DMC | 0.52; 140 (0.2C) | Li metal/LiCoO₂ | Enhanced tensile strength and |
| formaldehyde | microfiber | (1:1, v/v) | | | a suitable porous structure |
| PVA-co-PE | Al₂O₃ | 1M LiPF₆ in EC/DMC | 0.92; 157 (0.2C) | Li metal/LiFePO₄ | High porosity and superior electrolyte |
| | | (1/1, v/v) | | | affinity. |
| PEG | Al₂O₃ | 1M LiPF₆ in EC/DMC | 0.93; 156 (0.1C) | Graphite/LiNi_{1/3}Co_{1/3} | Excellent cycling stability and |
| | | (1:1, w/w) | | Mn_{1/3}O₂ | good rate performance. |
| Bacteria | SiO₂ | 1M LiPF₆ in EC/DEC | 6.5; 153 (0.1C) | Li metal/LiFePO₄ | Good thermal stability up to |
| Cellulose | | (1:1, w/w) | | | 200° C., and high ionic conductivity |
| HBPE | graphene oxide | 1M LiPF₆ in EC/ | 1.7; 118 (5C) | Li metal/LiFePO₄ | Improved electrochemical |
| | | DEM:EMC (1:1:1, w/w/ | | | performance |
| | | w) | | | |
| PPO | SiO₂ | 1M LiPF₆ in EC/DMG | 2.62; 142 (0.2C) | Li metal/LiFePO₄ | Improved discharge capacity |
| | | | | | and cycling stability. |
| PPC | Li_{6.75}La₃Zr_{1.75} | | 0.52; 120 (0.3C) | Li metal/LiFePO₄ | Excellent rate capability and cycling |
| | Ta_{0.25}O₁₂ | | | | stability. |
| Cellulose | HAP | 1M LiPF₆ in EG/DMC | 3.07; 138.(0.5C) | Li metal/LiFePO₄ | Excellent thermal stability, |
| | | (v/v) | | | fire resistance and improved |
| | | | | | electrolyte wettability. |
| bacterial | Nano ZrO₂ | 1M LiPF₆/EC + DEC | 2.14; 120 (2C) | Li metal/LiFePO₄ | High thermal resistance, electrolyte |
| cellulose | | (1/1, v/v) | | | wettability, and ionic conductivity |
| Succinonitrile | SiO₂ | — | 2; 151 (0.4C) | LiTi₅O₁₂/LiCoO₂ | Inhibition of lithium dendrite |
| | | | | | growth and improved electrochemical |
| | | | | | stability up to 5.2 V |
| P | SiO₂ | 1M LiPF₆ in EC/DEC | 2.27; 105 (0.5C) | Li metal/LiMn₂O₄ | Large electrolyte uptake and enhanced |
| | | (1/1, v/v) | | | conductivity. |

TABLE 8
Polymer blends based on different polymer matrices and their main properties for battery separators.

| | | Conductivity | | |
|---|---|---|---|---|
| | | (mS · cm⁻¹) and | | |
| Blend Materials | Electrolyte solution | capacity (mAh · g⁻¹) | Anode/Cathode | Main achievement |
| PS/PEO | — | ~0.1 at 80° C.; | — | Improved conductivity for PEO contents larger than 0.5% |
| PEO/PVP | — | −1.13 | Li metal/LiFePO₄ | Remarkable room temperature ionic conductivity, good |
| | | | | thermal stability and promising electrochemical activity |
| PEG/LC | 1M LiPF₆ in EC/DMC/DEC | 3.22; 166 (0.2C) | Li metal/LiFePO₄ | Lithium ion transference number of 0.81. Good |
| | | | | thermal and electrochemical stability. |
| PEO/PVC | — | 0.05; — | — | Significant ionic conductivity, |
| | | | | high ionic transference number, |
| | | | | and good thermal and voltage stability |
| HDPE/MC | 1M LiPF₆ in EC/DEM/EMC | 1.01; 160 (0.2C) | Li metal/LiFePO₄ | Higher charge -discharge capacity and better discharge |
| | | | | performance at various current densities. |
| PVDF-TrFE/ | 1M LiTFSI in PC | 0.54; 125 (C/5) | Li metal/LiFePO₄ | Diffusion dominated electrical properties |
| PEO | | | | and improved cycling performance. |
| PVDF/PAN | 1M LiPF₆ in RC/DMC:DEC | 2.9; 160 (0.2C) | Graphite/LiFePO₄ | Enhanced tensile strength and the thermal stability. |
| | (1:1:1, v/v/v) | | | |
| PVDF/PEO | 1.0M LiTFSI in EC:DEC | 4.2; 275 (0.1C) | Li metal/LiV₃O₈ | Dimensional stability at high temperature without thermal |
| | (1:1 vo]) | | | shrinkage and high ionic conductivity. |
| PVDF/PI | 1M LiPF₆ in EC/PC/DEC/VC | —; 141 (1C) | Mesocarbon | Superior thermal performance and long-term stability. |
| | (35.4/17.2/45.1/2.3 wt %) | | microbead/LiCoO₂ | |
| PAEK/PVDF | 1M LiPF₆ in EC/DMC (w, w) | —; 140 (0.5C) | Li metal/LiFePO₄ | High porosity, uniform distribution of pores with |
| | | | | interconnected pathways, low thermal shrinkage and high |
| | | | | liquid electrolyte uptake. |
| PVDF/CNF | LiPF&/EC/DEC/EMC, 1:1:1, | 1.26; 119 (0.5C) | Li metal/LiCoO₂ | Superior capacity retention and a better rate capability |
| | v/v/v | | | compared to the commercial separator. |
| PVDF/PEO | 1M LiPF₆ in EC:DMC, | 1; 140 (1C) | Li metal/LiFePO₄ | Improved conductivity, larger electrolyte uptake |
| | 1:1 w/w | | | and higher porosity than commercial polyolefines, |
| PVDF/ | 1M LiPF₆ in EC/DMC/EMC, | 1.3; | Graphite/LifePO₄ | High ionic conductivity. |
| PEGMRA/ | 1/1/1 wt) | | | |
| PEGDA | | | | |
| PVDF/HDPE | 1.0M LiPF₆ in EG/DMC/ | 2.54; 156.1 (0.1C) | Li metal/LiCoO₂ | Good C-rate and cycling performance |
| | EMC (1:1:1, v/v/v) | | | |
| PVDF/CA | 1.0M LiPF₆ in EG/DMC/ | 2.85; 128.28 (8C) | Li metal/LiCoO₂ | Higher electrolyte uptake, excellent thermal and |
| | EMC (1:1:1, wt/wt/wt) | | | electrochemical stability |
| PVDF/PFSA | 1.0M LiPF₆ in EC/DMC/ | 1.26; 137.9 (1C) | Li metal/LiFePO₄ | Higher discharge capacity and better stability |
| | EMC (1:1:1, v/v/v) | | | than the PVDF separator. |
| PBA/PVDF | 1.0 M LiFF₆ in EC/DMC/ | 0.81; 95 (0.1C) | Li metal/LiFePO₄ | Electrochemical stable window until 4.5 V |
| | DEC (1:1:1, v/v/v) | | | (vs. Li/Li⁺) and a good cycling stability. |
| PDMS/PAN/ | | 0.67; 114 (3C) | Li metal/LiFePO₄ | Improved lithium transport number increased up to 0.58 |
| PEO | | | | through the addition of PDMS. |
| PPC/Cellulose | 1M LiODFB-PC (1:1 vol) | 1.14; 100 (C) | Li metal/ | High voltage window (5.0 V), high ionic conductivity |
| | | | LiNi_{0.5}Mn_{1.5}O₄ | (1.14 mS/cm) and high lithium ion transfer number (0.68). |
| PVA/Cellulose | 1M LiPF₆ in EC/DEC/EMC | 1.1; 91.8 (4C) | Li metal/LiCoO₂ | Increased Li⁺ transport and specific capacity. |
| | (1:1:1, v/v/v) | | | |
| Epoxy/PGMA- | 1M LiPF₆ in EC/DEC | 0.71; — | — | Thermally resistant up to 200° C. |
| b-PHEMA | | | | |

TABLE 9
Recent scientific works on polymer electrolytes and the
corresponding characteristics for battery applications.

| | | Conductivity | Discharge capacity |
|---|---|---|---|
| Polymer | Fillers | (mS.cm-1) | (mAh/g) |
| PVDF | LATP | 0.63 (30° C.) | 127.8 (0.1C) |
| PVDF, PVC | LiTFSI, | 0.2 | 117.8 (0.1C) |
| | OMMT | | |
| PEO | LLZTO, | 0.024 | 165.9 (0.1C) |
| | LiBOB | | |
| PVDF | HNT | 0.35 (30° C.) | 71.9 (1C) |
| SCT | LiTSFI | ~0.1 | 145 (C/5) |
| PEO, PVDF | LiTFSI, POSS- | 0.8 (22° C.) | 119.4 (0.1C) |
| | IL | | |
| PEO | LiTFSI | 0.8 (60° C.) | 160 (0.2C) |
| PEGBCDMA | LiTFSI | 0.8 (25° C.) | 162 |
| PEO, PTHF | LiTFSI | 0.12 (30° C.) | 163 (0.1C) |
| PEG | LiB(OCH₃)₄ | 0.005 (25° C.) | 30 |
| PEO | LiGLO₄, Al- | 0.44 (30° C.) | 146 (0.06C) |
| | LLZO | | |
| PEO | LiTFSI, LLTO | 0.06 (25° C.) | 123 (0.50) |
| PEO | LiTFSI, LATP | 0.20 (23° C.) | 123.4 (0.05C) |
| PEC | LiFSI | 0.03 (60° C.) | ~140 (C/20) |

In particular embodiments, the separator layer or separator membrane can be applied to bare silicon (e.g., HF treated, no oxide layer) and/or functionalized surface (e.g., thin oxide on silicon functionalized by (3-Aminopropyl) trimethoxysilane), and the like.

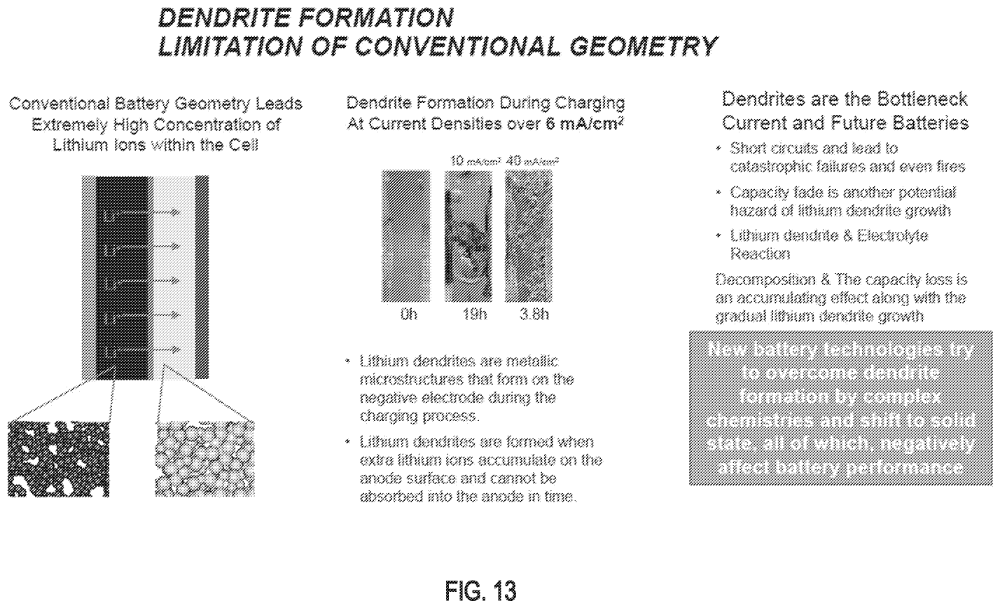

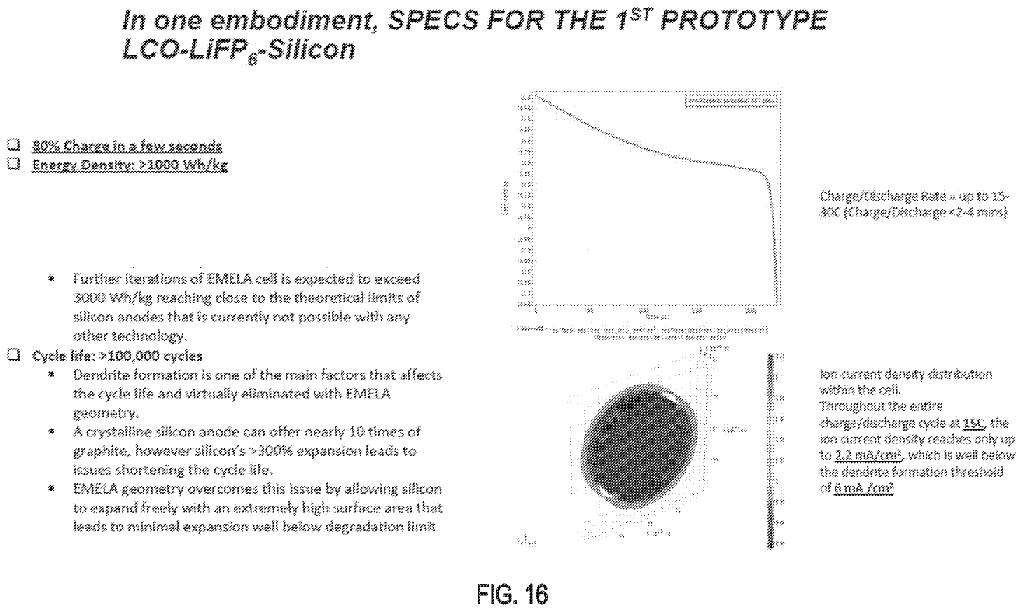

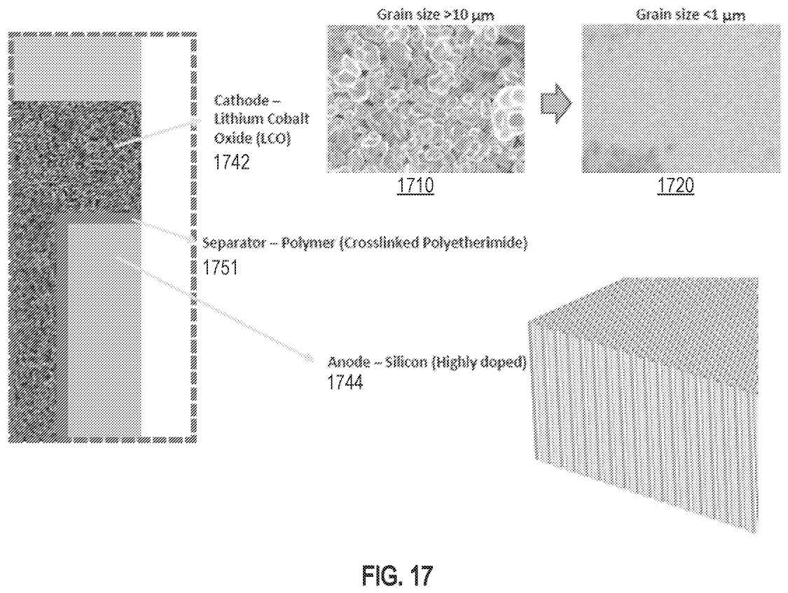

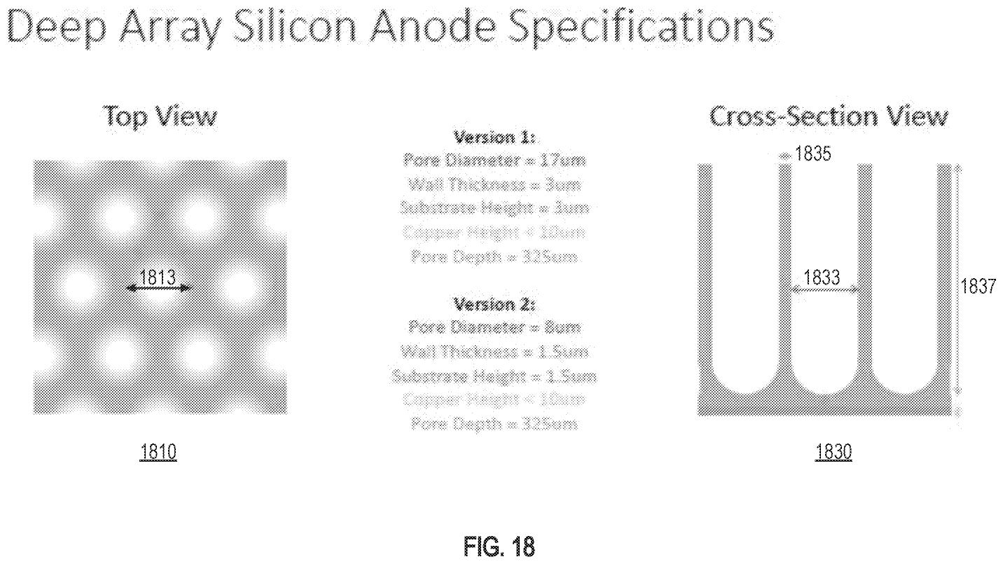

FIG. 13 is a diagram illustrating additional aspects of dendritic growth. FIG. 14 is a diagram illustrating a comparison between a standard battery structure and an EMELA battery structure using a deep hole array silicon substrate. FIG. 15 is a diagram illustrating additional details of the EMELA battery structure illustrated in FIG. 14 in accordance with some aspects of the disclosure. FIG. 16 is a diagram illustrating charging/discharging rates and ion current densities associated with a particular embodiment in accordance with some aspects of the disclosure. FIG. 17 is a diagram illustrating additional details of the EMELA battery structure illustrated in FIGS. 14 and 15 in accordance with some aspects of the disclosure. For example, diagrams 1710 and 1720 illustrate that a cathodic material associated with the EMELA battery structure used in some aspects (as illustrated in diagram 1720) may be more finely milled (include particles of smaller size) than a cathodic material associated with a standard battery construction (as illustrated in diagram 1710). As illustrated in FIGS. 14, 15, and 17, the pores of the deep array, or the holes of a deep hole array, in some aspects, may be considered to be connected by the layer of cathode material (the portion of the CCPN corresponding to the cathode-only zone 842, 1442, 1542, or 1742). In some aspects, the cathodic current collector (or terminal) 1441 or 1551 may be in contact with the separator layer 1451 or 1551 effectively separating the pores into individual battery elements (e.g., micro-, or nano, battery devices) comprising the substrate material surrounding each pore and the CCPN within the pore. Each individual battery element may be connected to a common cathodic current collector 1441 or 1541 and a common anodic current collector 1445 or 1545 to form an array of battery elements connected in parallel to a shared set of terminals. FIG. 18 is a diagram illustrating additional details of the EMELA battery structure illustrated in FIGS. 14, 15, and 17 in accordance with some aspects of the disclosure. For example, diagram 1810 illustrates a top view of an example porous structure with a pore diameter 1813 and diagram 1830 illustrates a cross-section view of an example porous structure with a pore diameter 1833, wall thickness 1835, and depth 1837.

What is claimed is:

1.-3. (canceled)

4. An embedded electrode assembly (EMELA), comprising:
a deep-pore-array silicon substrate (DPASS) capable of conducting or storing a charge, wherein the DPASS comprises an array of a plurality of pores extending into the DPASS,
a continuous conductive particle network (CCPN) comprising a plurality of particles, wherein particles of the plurality of particles are dispersed within the plurality of pores of the DPASS; and
a non-electrically-conductive separator layer interposed between the DPASS and the CCPN.

5. The EMELA of claim 4, wherein substantially all of the plurality of particles are in direct contact with two or more particles of the plurality of particles forming the CCPN.

6. The EMELA of claim 4, further comprising an anodic component electrically separate from the CCPN and electrically connected to the substrate.

7. The EMELA of claim 6, wherein the anodic component comprises an anodic current collector.

8. The EMELA of claim 4, further comprising a cathodic component electrically separate from the substrate, and electrically connected to the CCPN.

9. The EMELA of claim 8, wherein the cathodic component comprises a cathodic current collector.

10. The EMELA of claim 4, further comprising an electrolyte material comprising a medium for a transfer of ions between the CCPN and the substrate.

11. The EMELA of claim 10, wherein the electrolyte material comprises a solvent and a solute.

12. The EMELA of claim 11, wherein the electrolyte material comprises a solid state electrolyte material, the solid state electrolyte material being a conductor for the ions and an insulator for electrons.

13. The EMELA of claim 4, wherein the substrate comprises a silicon-based substrate and the CCPN comprises a lithium-based particle; or wherein the substrate, comprises a carbon-based substrate and the CCPN, comprises a lithium-based particle.

14. (canceled)

15. The EMELA of claim 4, wherein the non-electrically-conductive separator layer is ionically conductive such that electrons cannot pass between the CCPN and the substrate and ions can pass between the CCPN and the substrate.

16. The EMELA of claim 15, wherein the non-electrically-conductive separator layer has a thickness of one of 0.1 to 100 nm, 10 nm to 5 microns, or 10 nm to 10 microns; or wherein the non-electrically-conductive separator layer is an oxide or polymer layer formed on a surface of the substrate; or wherein the non-electrically-conductive separator layer is deposited on a surface of the substrate.

17.-21. (canceled)

22. The EMELA of claim 4, wherein an average ionic diffusion distance for ions diffusing from the CCPN, to the substrate, is less than at least one of: 100 μm, 50 μm, 10 μm, 1 μm, 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 20 nm, 10 nm, 9 nm, 8 nm, 7 nm, 6 nm, 5 nm, 4 nm, 3 nm, 2 nm, or 1 nm; or wherein a characteristic size of the network of interconnected empty volumes or the plurality of pores is less than at least one of: 100 μm, 50 μm, 10 μm, 1 μm, 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 20 nm, 10 nm, 9 nm, 8 nm, 7 nm, 6 nm, 5 nm, 4 nm, 3 nm, 2 nm, or 1 nm; or wherein a characteristic size of conductive particles in the plurality of conductive particles is less than one of: 90%, 80%, 70%, 60%, 50%, 40%, 30%, 20%, 10%, 9%, 8%, 7%, 6%, 5%, 4%, 3%, 2%, or 1% of the characteristic size of the network of interconnected empty volumes or the plurality of pores; or wherein a standard deviation of a size of conductive particles in the plurality of conductive particles is one of: 1%, 3%, 5%, 10%, 15%, 20%, 25%, 30%, 35%, 40%, 45%, or 50% of the characteristic size of the conductive particles in the plurality of conductive particles.

23.-29. (canceled)

30. The EMELA of claim 4, wherein an average distance from any point within the CCPN, to a closest point within the substrate, is less than at least one of: 100 μm, 50 μm, 10 μm, 1 μm, 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 20 nm, 10 nm, 9 nm, 8 nm, 7 nm, 6 nm, 5 nm, 4 nm, 3 nm, 2 nm, or 1 nm; or wherein a ratio between a surface area of an interface between the substrate, and the CCPN, and a volume of the EMELA is greater than 200 cm-1, 500 cm-1, 1000 cm-1, 5000 cm-1, 1×104 cm-1, 5×104 cm-1, 1×105 cm-1, 1×106 cm-1, 1×107 cm-1, or 1×108 cm-1; or wherein the substrate comprises one or more of: 1%, 5%, 10%, 15%, 20%, 25%, 30%, 35%, 40%, 45%, or 50% of unfilled volume after the conductive particles are embedded within the substrate.

31.-32. (canceled)

33. The EMELA of claim 30, wherein the unfilled volume accommodates expansion of the substrate, during a charging operation.

34.-36. (canceled)

37. The EMELA of claim 4, wherein the substrate, comprises at least a first type of anode particle, or anode material, and a second additive component.

38. The EMELA of claim 37, wherein the second additive component is one of an additive particle, ion, or element increasing a conductivity of the substrate, or a binder increasing a structural integrity of the substrate.

39. The EMELA of claim 4, wherein the CCPN, comprises at least a first cathode particle type and a second additive component.

40. The EMELA of claim 39, wherein the second additive component is one of an additive particle increasing a conductivity of the CCPN, or a binder increasing a structural integrity of the CCPN.

41. The EMELA of claim 4, wherein the substrate, comprises a doped silicon, wherein a doping of the doped silicon increases electrical conductivity of the doped silicon compared to an undoped silicon; or wherein the non-electrically-conductive separator layer is selected from the group consisting of: 1,4-butanediol diglycidyl ether; Single-layer PE: Single-layer PP; Ceramic-coated PP; Trilayer PP/PE/PP; or the separator layers set forth in Tables 1-9.

42. (canceled)
